(19) United States
(12) Patent Application Publication
(10) Pub. No.: US 2013/0061414 A1
(43) Pub. Date: Mar. 14, 2013

(54) Methods and Devices for Cleaning Implements

(71) Applicants: Francisca Swist, Edmonton (CA); Jason Swist, (US)

(72) Inventors: Francisca Swist, Edmonton (CA); Jason Swist, (US)

(21) Appl. No.: 13/606,159

(22) Filed: Sep. 7, 2012

Related U.S. Application Data
(60) Provisional application No. 61/532,161, filed on Sep. 8, 2011.

(51) Int. Cl. A47L 13/10; B23P 17/04

(52) U.S. Cl. 15/209.1; 29/428

(57) ABSTRACT

A cleaning system is provided comprising a compliant pad and a consumable pad for use in conjunction with a variety of cleaning implements. The compliant pad may according to embodiments of the invention provide for both compliance to the contour of the surface being cleaned but also allows for the compliant pad to provide for controlled release of fragrance, solvents, cleaning agents etc within the matrix or matrices provided in its construction. Likewise the consumable pad may provide elements providing dust attraction/retention, abrasion, as well as controlled release of fragrance, solvents, cleaning agents etc within the materials provided in its construction. According to embodiments of the invention the compliant pad and/or consumable pad are water soluble to provide this release wherein the water is provided either from within one or both of the compliant pad and consumable pad or from the cleaning implement to which they are attached.

### CROSS-REFERENCE TO RELATED APPLICATIONS

This patent application claims the benefit of U.S. Provisional Patent Application U.S. 61/532,161 filed Sep. 8, 2011 entitled “Methods and Devices for Cleaning Implements” the entire contents of which are incorporated by reference.

### FIELD OF THE INVENTION

This invention relates to cleaners and more specifically baseboard, cornice, and panel cleaners with disposable cleaning pads.

### BACKGROUND OF THE INVENTION

Over the past few hundred years cleaning was primarily a highly manual task employing a cloth or mop, water and soap wherein any surfaces other than the floor were rubbed with the cloth, which was rung out into the container with the soap and water. Whilst removing the worst dirt generally the result was the dispersal of the dirt in a thin film over the surfaces. In the past hundred years the advent of residential electricity, plastics, Freon propellants, consumerism, socio-economic changes, and other factors have resulted in a plethora of cleaning utensils being developed and marketed with the intention of easing the consumers load in cleaning their living environment. However, when considering the surfaces within these living environments there has been very little innovation in anything other than essentially planar surfaces. Accordingly, vacuum cleaners, brushes, brooms, and disposable pad system in dry and wet formats have been primarily targeted at the large flat flooring areas of our living environments where surfaces such as carpet, tile, ceramics, and wood provide different requirements but are essentially planar areas to be cleaned. Similarly disposable pads and disposable dusters alone or in combination with tools provide consumers with cleaning supplies for areas such as shelves, consumer electronics, book cases and other areas.

However, within these living environments there are a variety of treatments for walls either disposed at points along their surface or at their joints with ceilings and floors. Amongst these treatments are cornices, panel moldings, casings, baseboards, door jambs, crown moldings, covings, picture rails, and chair rails. These surfaces present a very different problem to consumers of these existing cleaning products as these are either at locations that are difficult to reach, i.e. coving at the wall—ceiling interface or have complex surface profiles, i.e. baseboards and chair rails that are difficult to clean with existing products.

Within the prior art the cleaning of baseboards has been an area of development as evident from the different innovations presented in respect of FIGS. 1 through 4. Referring to FIG. 1 there is shown a hand-held utensil in open position 120 and partially closed position 100 as taught by B. Johnson in U.S. Pat. No. 4,893,369 entitled “Hand-Held Utensil for Surface Cleaning, Mopping and the Like” wherein a sponge surface for soap and water is presented that provides with the ability to squeeze the dirty fluid from the utensil by transitioning the utensil from the open position 120, through the partially closed position 100 to a closed position, not shown for clarity. However, the sponge suffers the same drawbacks as conventional mops such as bacterial growth within the sponge but requires the user to be close to the surface being cleaned.

Cleaning brush 140 according to the prior art of C. A. Belinsky in U.S. Patent 2005/0,158,116 entitled “Cleaning Apparatus and Method for Using the Same” provides a handheld battery powered brush for providing mechanical brushing action. Cleaning brush 140 is primarily targeted to hard surfaces by providing a cleaning means, particularly an abrasive cleaning means, such as a brush, abrasive pad or other physical means. The cleaning brush 140 includes a chemical cleaning composition which is provided in a pressurized or pressurizable vessel. Accordingly, the cleaning brush 140 is intended for use with toilets.

Also depicted by partially attached 160 and attached 180 images a disposable cover for a handheld cleaning implement, such as a sponge, is depicted according to the prior art of J. J. Dillon in US Patent Application 2005/0,273,958 entitled “Sponge and Cloth Cleaning Device.” Whilst this addresses some issues of sponges the invention primarily does not advance the basic manual scrubbing of surfaces.

Referring to FIG. 2 there is depicted a utensil 200 and disposable scrubber 220 according to the prior art of R. J. LaFlamme et al in U.S. Patent Application 2008/0,205,972 entitled “Surface Cleaner with Removable Wand.” LaFlamme teaches a surface scrubbing device, i.e. utensil 200 that includes a pad base member, disposable scrubber 220 that has at least one exit port with a connection structure provided on the pad base member. A storage chamber is provided within the scrubbing pad member with fluid stored therein. A user manipulatible valve is provided in communication with the storage chamber so that depression of the button urges fluid the storage chamber through the exit port and to the surface engaging member. A wand is removably connected to the pad member via the connection means to extend the reach of the scrubbing device.

Also depicted in FIG. 2 is a cleaning implement 240 according to the prior art of A. Sgrol et al in US Patent Application 2010/0,017,992 entitled “Cleaning Implements” for cleaning a ceiling fan blade is provided. The cleaning implement includes a frame, a single cleaning cloth, and gripping portion. The frame has an open end and a closed end opposite the open end so that the frame defines a fan blade receiving opening. Cleaning implement 240 is intended for cleaning a fan blade and only a fan blade, but demonstrates current consumer willingness to purchase application specific tools if they provide a reduction in time, increased ease of cleaning etc.

Electric cleaner 260 according to the prior art of S. A. Hall in U.S. Pat. No. 5,371,912 entitled “Floor and Baseboard Cleaning Machine.” Electric cleaner 260 is an electric floor and baseboard cleaning machine which includes a motor assembly in which the movement is adjustable for either straight line or circular motion. The electric cleaner 260 has fixed and pivotal sections and the pivotal sections can be manually adjusted from a vertical to a horizontal position. For cleaning vertical baseboards the pivotal section is secured in an upright posture and when used to clean floors it is affixed in a downward or horizontal position. Cleaning media such as non-woven pads are affixed to the frame and two such pads can be used, one for the pivotal frame section and the other for the fixed frame section. The electric cleaner 260 also includes an electric pump and liquid reservoir for directing a cleaning or other fluid as desired to a spray nozzle located near the cleaning medium. Electric cleaner 260 is a large electric powered machine similar to a vacuum cleaner or floor cleaning/buffing device. Accordingly, it is not a device that a consumer would purchase for their residential baseboard cleaning due to cost, size etc. Further the non-woven pads are described as coming in a variety of grades for scouring, cleaning, polishing, buffing, waxing, etc and that the same pad is used for both the floor (when in horizontal position) and baseboard (when in vertical position). As such these pads are primarily designed for the cleaning of flat continuous surfaces and not contoured surfaces.

Referring to FIG. 3 there is depicted a mop 300 according to the prior art of K. Cioci in U.S Patent Application 2009/0,235,476 entitled “Mop for Use on Baseboard and the Like” wherein a floor mop with pad is provided with one, or two wings, that are pivotable between a substantially horizontal orientation and a substantially vertical orientation. In this manner when in the vertical position the wing cleans a predetermined height of a baseboard. However, baseboards come in a wide range of profiles and heights, which can exceed 300 mm (12 inches). Such wings would make the mop extremely large and hence it is suited to the lower few inches. Further as the consumer essentially pushes the mop parallel to the baseboard the amount of pressure applied is low such that the wing is particularly suited to simple flat baseboards.

Also depicted is a scrubber 320 according to the prior art of R. Mejia et al in U.S. Pat. No. 5,331,703 entitled “Power Driven Floor and Wall Scrubber” which comprises a triangular frame assembly with a pair of flat elongated plates mounted that can move along the length of the frame and motor for reciprocating in alternate longitudinal directions the pates relative to the frame such that pads attached to the plates brush the floor and baseboard at the same time. Again, the design does not provide pressure of the pad against the baseboard so that it is again particularly suited to flat baseboard surfaces.

Vacuum cleaner 340 also depicted in FIG. 3 presents the prior art of G. L. Farmer in U.S. Pat. No. 4,198,727 entitled “Baseboard Dusters for Vacuum Cleaners” wherein the base housing of the vacuum cleaner 340 is modified to include openings on the sides to which brushes can be mounting so that the brushes sweep across the baseboards whilst the vacuum cleaner 340 is being moved about to clean the carpet in a room. As such the vacuum cleaner 340 is limited to the brush configuration/base housing design tradeoff.

Now referring to FIG. 4 there is depicted a baseboard cleaner 400 according to the prior art of J. Avila in U.S. Pat. No. 7,418.758 entitled “Baseboard Cleaning Apparatus” wherein the baseboard cleaner 400 comprises an extendable handle to which a wheel is attached wherein a side frame to the housing of the baseboard cleaner has an adsorbent/desorbent pad attached. There is also a pad compression device allowing the pad, which is in reality a sponge, to be folded over and squeezed. The overall baseboard cleaner 400 is assembled in a manner such that the lower end can be immersed in a bucket of water and the pad squeezed.

Also depicted in FIG. 4 is baseboard cleaning device 420 according to the prior art of Y. Sandoval in U.S. Pat. No. 7,296,943 entitled “Baseboard Cleaning Apparatus and Method.” Like baseboard cleaner 400 the baseboard cleaning device 420 comprises a housing having wheels and a handle wherein attached to the housing are two pads, which are taught as being typically a wet sponge and a dry cloth. Accordingly in use the wet sponge wipes the baseboard and the dry cloth dries it. The baseboard cleaning device 420 may also comprise a liquid dispenser to keep the sponge wet. Sandoval also teaches to the use of top pads for cleaning a top face of the baseboard since is evident from FIG. 5 the commonly installed basic baseboards have a simple flat upper surface.

FIG. 4 also depicts rotary brush 440 according to the prior art of A. A. Lavender in U.S. Pat. No. 7,114,214 entitled “Baseboard Brush.” Rotary brush 440 simultaneously cleans and/or polishes floors and baseboards on the basis that the brush is adapted to be utilized with conventional commercial buffing machines. In its cleaning mode, the brush incorporates bristles on its planar undersurface and also entirely around its peripheral wall. There is also a polishing pad option to be secured around the peripheral wall of the brush for contacting and polishing the baseboards.

Now referring to FIG. 5 a sample of baseboard designs commercially available are depicted. In addition to a wide range of convex/concave/planar surfaces to be cleaned these are also available in multiple heights and thicknesses so that the dimensions of the surface features may additionally vary as well as their combination. Likewise referring to FIG. 6 there is depicted first array 600 which shows some of the cornice designs available for use at the joint between the ceiling and wall to provide a design feature. Also depicted in FIG. 6 is second array 650 which shows some of the casing designs available for use around openings such as doors, windows and archways which similarly come in a variety of widths.

However, it is evident from the multiple solutions presented above in respect of FIGS. 1 through 4 that in many instances these are targeted to commercial cleaning applications by providing either modifications to existing commercial cleaning equipment or are themselves quite substantial items of equipment. In other instances the equipment whilst addressing residential/consumer use are either variations of other prior art approaches, such as disposable sponge covers or folding handheld sponges, or have limited application through their design, such as brushes on the side of a vacuum cleaner.

Additionally, as noted above and discussed in respect of FIGS. 5 and 6 above the profile of the elements upon the walls of the residential environment are generally both function and decorative with complex profiles. Further cornices, panel moldings, casings, door jambs, crown moldings, coving, picture rails and chair rails are all disposed at different vertical locations on these walls rather than only at the floor/wall joint as is the case with baseboards.

Accordingly it would be beneficial to provide a low cost, flexible solution to the problem of cleaning multiple contoured elements at the bottom, top, and in-between on their walls which gather dust and dirt like all other surfaces in the house. It would be further beneficial if the solution allowed both wet and dry cleaning and could handle a wide range of surface profiles and dimensions of the elements being cleaned.

### SUMMARY OF THE INVENTION

It is an object of the present invention to

In accordance with an embodiment of the invention there is provided a method comprising providing a compliant pad for demountable attachment to a cleaning implement, the compliant pad being formed from a material allowing the compliant pad to approximately match the contour of a surface to which it is applied, and providing a consumable pad for demountable attachment to at least one of the compliant pad and the cleaning implement wherein the consumable pad is disposed between the compliant pad and the surface and provides for retention of material transferred from the surface to the consumable pad during a movement of the consumable pad relative to the surface.

In accordance with an embodiment of the invention there is provided a device comprising a compliant pad for demountable attachment to a cleaning implement, the compliant pad being formed from a material allowing the compliant pad to approximately match the contour of a surface to which it is applied, and a consumable pad for demountable attachment to at least one of the compliant pad and the cleaning implement wherein the consumable pad is disposed between the compliant pad and the surface and provides for retention of material transferred from the surface to the consumable pad during a movement of the consumable pad relative to the surface.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts cleaning implements according to the prior art for non-flooring constructional elements of a building;

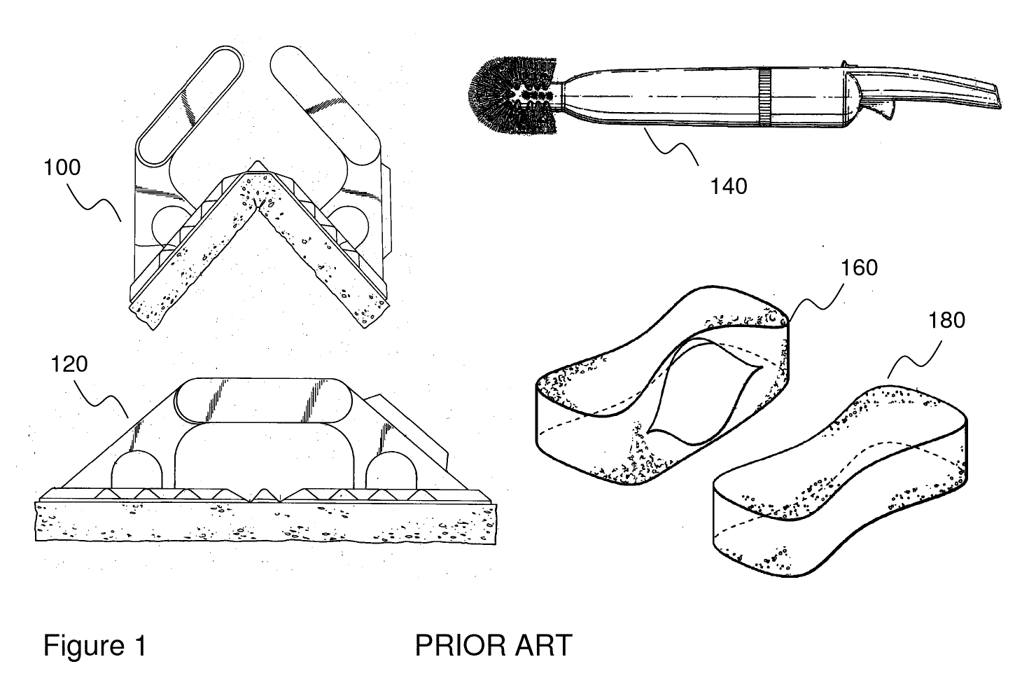

FIG. 2 depicts cleaning implements according to the prior art for non-flooring constructional elements of a building;

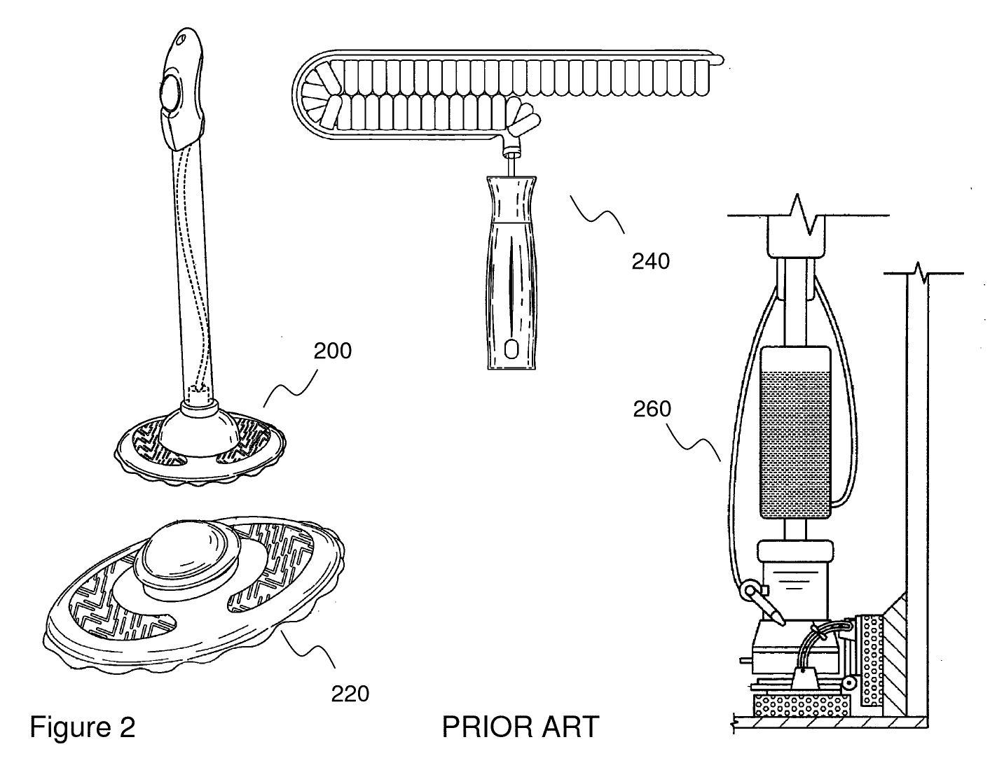

FIG. 3 depicts cleaning implements according to the prior art for non-flooring constructional elements of a building;

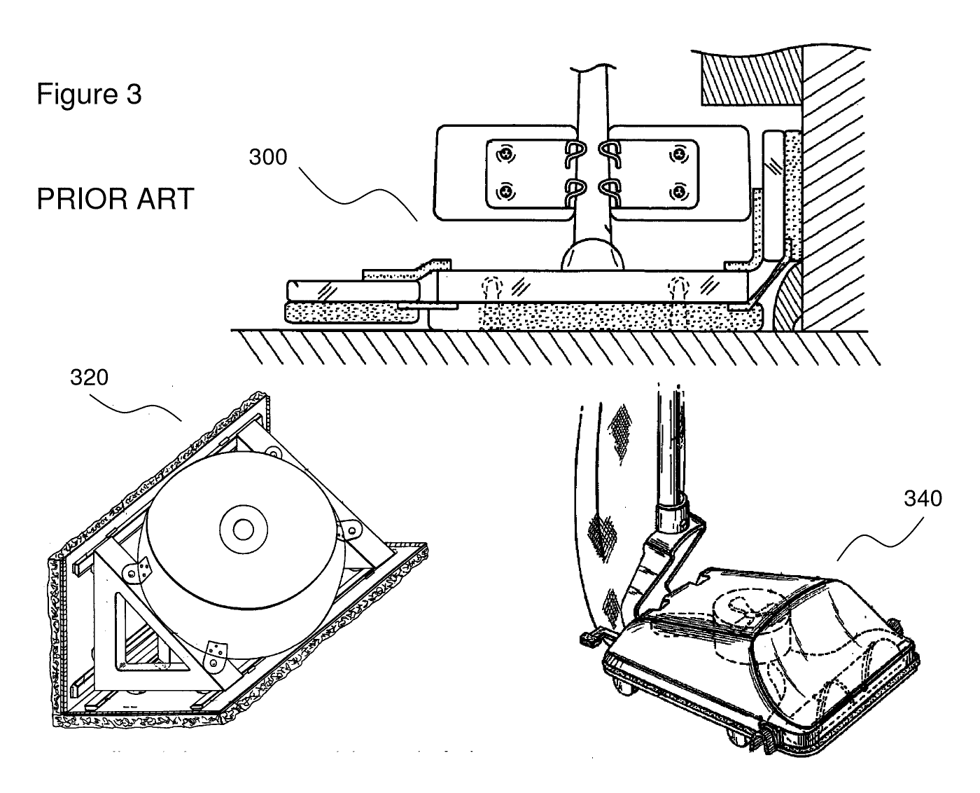

FIG. 4 depicts cleaning implements according to the prior art for non-flooring constructional elements of a building;

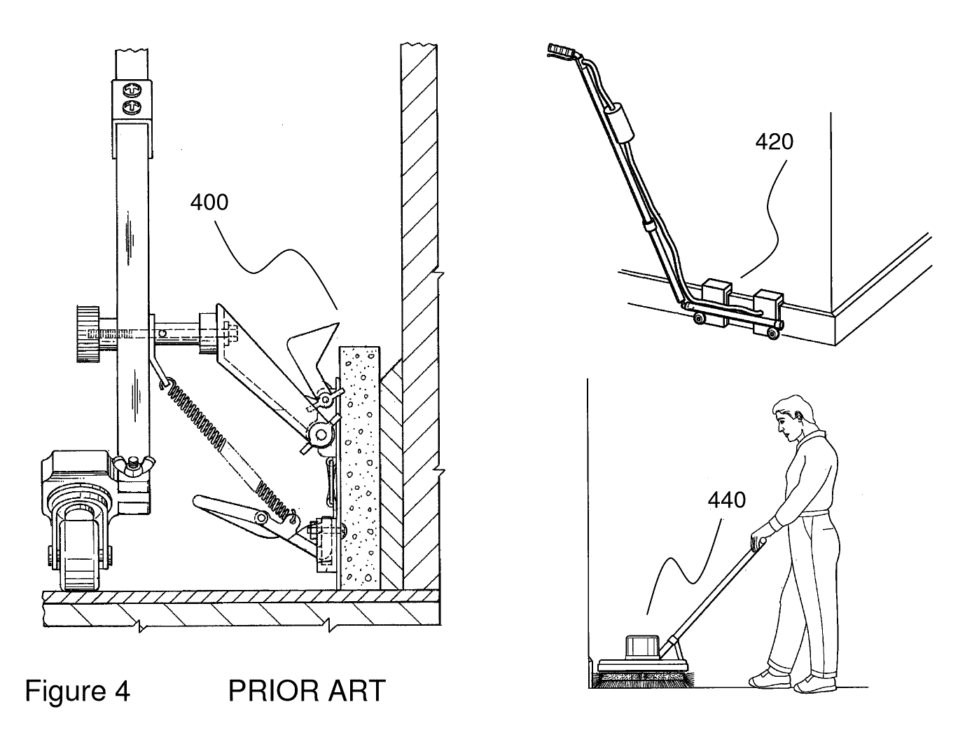

FIG. 5 depicts profiles of baseboards employed as non-flooring constructional elements of a building;

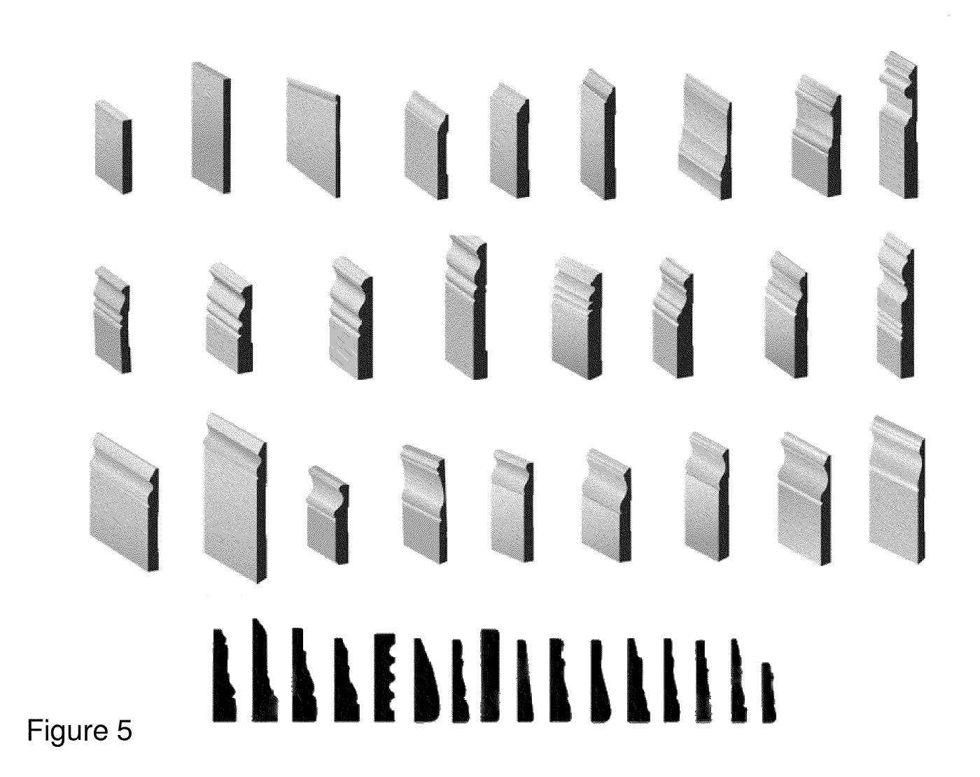

FIG. 6 depicts profiles of cornices and casings employed as non-flooring constructional elements of a building;

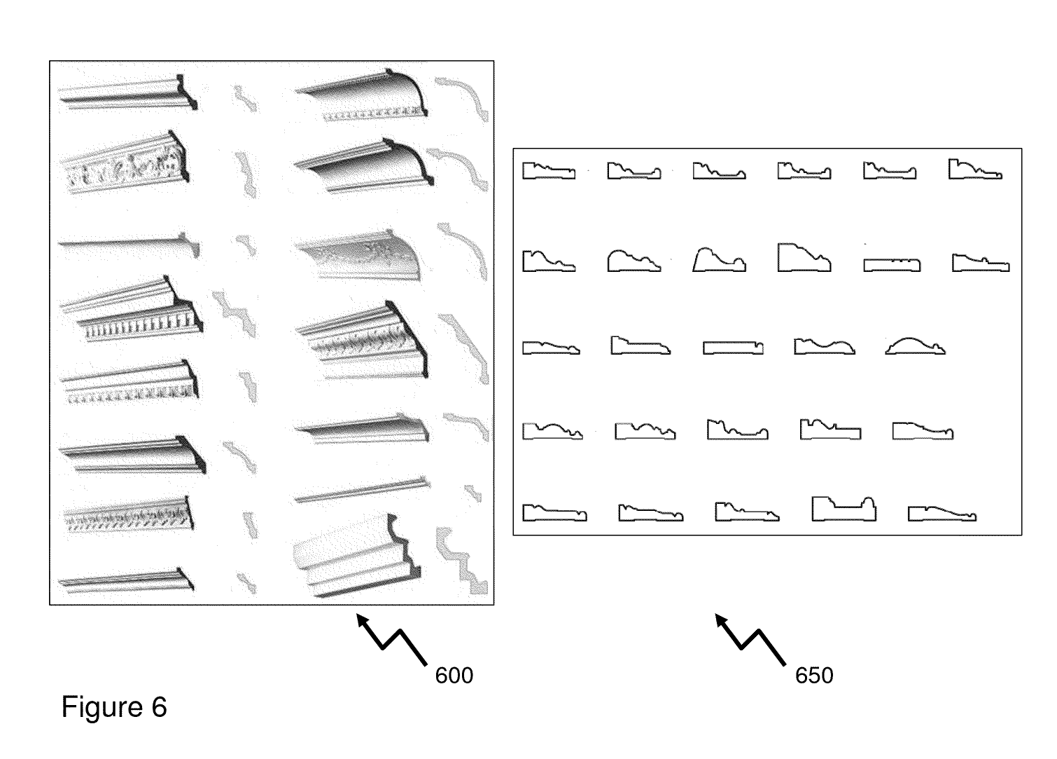

FIG. 7A depicts cleaning implements for use in conjunction with compliant pads and/or consumable pads according to embodiments of the invention;

FIG. 7B depicts cleaning implements for use in conjunction with compliant pads and/or consumable pads according to embodiments of the invention;

FIG. 8 depicts a compliant pad according to an embodiment of the invention;

FIG. 9 depicts a compliant pad consumable pad configuration according to an embodiment of the invention;

FIG. 10 depicts compliant pad and consumable pad configurations according to an embodiment of the invention;

FIG. 11 depicts compliant pad and consumable pad configurations according to an embodiment of the invention;

FIG. 12 depicts consumable pad configurations according to embodiments of the invention;

FIG. 13 depicts a system for manufacturing consumable pads according to an embodiment of the invention;

FIG. 14 depicts a compliant pad according to an embodiment of the invention;

FIG. 15 depicts the application of compliant pads and consumable pads according to embodiments of the invention to different cleaning implements.

### DETAILED DESCRIPTION

The present invention is directed to baseboard cleaners and more specifically baseboard cleaners with disposable cleaning pads.

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

It must be noted that, as used in this specification and the appended claims, the singular forms “a,” “an” and “the” include plural referents unless the content clearly dictates otherwise. Thus, for example, reference to a “surfactant” includes two or more such surfactants.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

The cleaning approach as described in respect of embodiments of the invention with respect to the consumable pad and/or compliant pad may include the use of disinfecting or sanitizing consumable pad and/or compliant pads for use as disinfectant, sanitizer, and/or sterilizer in combination with or in isolation from a consumable pad and/or compliant pad solely for a cleaning action. As used herein, the term “disinfect” shall mean the elimination of many or all pathogenic microorganisms on surfaces with the exception of bacterial endospores. As used herein, the term “sanitize” shall mean the reduction of contaminants in the inanimate environment to levels considered safe according to public health ordinance, or that reduces the bacterial population by significant numbers where public health requirements have not been established. As used herein, the term “sterilize” shall mean the effective elimination or destruction of all forms of microbial life.

As used herein, the term “consumable pad and/or compliant pad” is intended to include any web which is used to clean an article or a surface and which is attached to a cleaning implement. As used herein, “film” refers to a polymer film including flat nonporous films, and porous films such as microporous, nanoporous, closed or open celled, breathable films, or apertured films. As used herein, “wiping” refers to any shearing action that the consumable pad and/or compliant pad undergoes while in contact with a target surface. This includes hand or body motion, consumable pad and/or compliant pad-implement motion over a surface, or any perturbation of the consumable pad and/or compliant pad via energy sources such as ultrasound, mechanical vibration, electromagnetism, and so forth.

As used herein, the term “nonwoven web” means a web having a structure of individual fibers or threads which are interlaid, but not in an identifiable manner as in a knitted web. Nonwoven webs have been formed from many processes, such as, for example, melt blowing processes, spun bonding processes, and bonded carded web processes. As used herein, the term “spun bonded fibers” refers to fibers which are formed by extruding molten thermoplastic material as filaments from a plurality of fine, usually circular capillaries of a spinner with the diameter of the extruded filaments then being rapidly reduced. Spun bond fibers are generally not tacky when they are deposited onto a collecting surface. Spun bond fibers are generally continuous and have average diameters ranging from a few microns to tens of microns. As used herein, the term “melt blown fibers” means fibers formed by extruding a molten thermoplastic material through a plurality of fine, usually circular, die capillaries as molten threads or filaments. Melt blown fibers are microfibers, which may be continuous or discontinuous, and are generally smaller than 10 microns in average diameter, and are generally tacky when deposited onto a collecting surface.

As used herein, the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “conjugate fibers” refers to fibers or filaments which have been formed from at least two polymers extruded from separate extruders but spun together to form one fiber. Conjugate fibers are also sometimes referred to as “multicomponent” or “bicomponent” fibers or filaments. The term “bicomponent” means that there are two polymeric components making-up the fibers. The polymers are usually different from each other though conjugate fibers may be prepared from the same polymer, but the polymers are different from one another in some physical property, such as, for example, melting point or the softening point. The polymers are arranged in substantially constantly positioned distinct zones across the cross-section of the multicomponent fibers or filaments and extend continuously along the length of the multicomponent fibers or filaments. The configuration of such a multicomponent fiber may be, for example, a sheath/core arrangement, wherein one polymer is surrounded by another.

As used herein, the term “multiconstituent fibers” refers to fibers which have been formed from at least two polymers extruded from the same extruder as a blend or mixture. Multiconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random.

The term “sponge”, as used herein, is meant to mean an elastic, porous material, including, but not limited to, compressed sponges, cellulosic sponges, reconstituted cellulosic sponges, cellulosic materials, foams from high internal phase emulsions, such as those disclosed below in respect of High Internal Phase Emulsions (HIPE), polyethylene, polypropylene, polyvinyl alcohol, polyurethane, polyether, and polyester sponges, foams and nonwoven materials, and mixtures thereof.

The term “cleaning composition”, as used herein, is meant to mean and include a cleaning formulation having at least one surfactant. The term “surfactant”, as used herein, is meant to mean and include a substance or compound that reduces surface tension when dissolved in water or water solutions, or that reduces interfacial tension between two liquids, or between a liquid and a solid. The term “surfactant” thus includes anionic, nonionic and/or amphoteric agents.

High Internal Phase Emulsion Based Foams: Open-celled foams prepared from High Internal Phase Emulsions (hereinafter referred to as “HIPEs”) are particularly useful in a variety of applications including absorbent disposable articles as the manufacturing process provides facile control over the density, cell and pore size and distribution, proportion of cell struts to windows, and porosity in these foams. The physical properties of the foam are governed by: (1) the properties of the polymer from which the foam is comprised, (2) the density of the foam, (3) the structure of the foam (i.e. the thickness, shape and aspect ratio of the polymer struts, cell size, pore size, pore size distribution, etc.), and (4) the surface properties of the foam (e.g., whether the surface of the foam is hydrophilic or hydrophobic).

The continuous oil phase of the HIPE comprises monomers that are polymerized to form the solid foam structure and the emulsifier necessary to stabilize the emulsion. In general, the monomers will include from about 20% to about 95% by weight of at least one substantially water-insoluble monofunctional monomer capable of forming an atactic amorphous polymer having a low glass transition temperature (T_{G}) of about 35° C. or lower. This co-monomer is added to lower the overall T_{G} of the resulting HIPE foam. Exemplary monomers of this type include C4-C14 alkyl acrylates and C6-C16 methacrylates such as 2-ethylhexyl acrylate, n-butyl acrylate, hexyl acrylate, n-octyl acrylate, nonyl acrylate, decyl acrylate, isodecyl acrylate, tetradecyl acrylate, benzyl acrylate, nonyl phenyl acrylate, hexyl methacrylate, octyl methacrylate, nonyl methacrylate, decyl methacrylate, isodecyl methacrylate, dodecyl methacrylate, and tetradecyl methacrylate; substituted acrylamides, such as N-octadecyl acrylamide; dienes such as isoprene, butadiene, chloroprene, piperylene, 1,3,7-octatriene, β-myrcene and amyl butadiene; substituted C4-C12 styrenics such as p-n-octyl styrene; and combinations of such monomers. The T_{G} lowering mono-functional monomers will generally comprise 20% to about 95%, more preferably 45% to about 65%, by weight of the monomer component.

The oil phase will also comprise from about 5% to about 80% by weight of a first substantially water-insoluble, poly-functional crosslinking agent. This co-monomer is added to confer strength to the resulting HIPE foam. Exemplary crosslinking monomers of this type encompass a wide variety of monomers containing two or more activated vinyl groups, such as the divinyl benzenes and analogs thereof. These analogs include mp-divinyl benzene mixtures with ethyl styrene, divinyl naphthalene, trivinyl benzene, divinyl alkyl benzenes, divinyl biphenyls, divinyl phenyl ethers, divinyl ferrocenes, divinyl furans, and the like. Other useful crosslinking agents may be selected from a group derived from the reaction of acrylic acid or methacrylic acid with polyfunctional alcohols and amines. Non-limiting examples of this group include 1,6-hexanedioldiacrylate, 1,4-butanedioldimethacrylate, trimethylolpropane triacrylate, hexamethylene bisacrylamide, and the like. Other examples of crosslinking monomers include divinyl sulfide, divinyl sulfone, and trivinyl phosphine. Other crosslinkers useful in this regard are well known to those skilled in the art. It should be noted that the weight fraction of the crosslinking component is calculated on the basis of the pure crosslinker in cases wherein the crosslinking monomer is commonly used as a mixture (e.g., divinyl benzene often is a 55% pure mixture with the balance being ethyl styrene).

Any third substantially water-insoluble co-monomer may be added to the oil phase in weight percentages of from about 0% to about 70%, although typically from about 15% to about 40%, to modify properties in other ways. In certain cases, “toughening” monomers may be desired which impart toughness to the resulting HIPE foam equivalent to that provided by styrene. These include styrenics such as styrene and ethyl styrene and methyl methacrylate. Also include are styrenics and other compounds which may also help reduce the T_{G} or enhance the strength of the resulting HIPE foam such as p-n-octyl styrene. Monomers may be added to confer flame redundancy or may be added to confer other properties including but not limited color, fluorescent properties, disperse charge, and to form a wettable surface on the HIPE foam struts.

The discontinuous internal phase of the HIPE is generally an aqueous solution containing one or more dissolved components. One essential dissolved component of the water phase is a water-soluble electrolyte. The dissolved electrolyte minimizes the tendency of monomers, comonomers, and crosslinkers that are primarily oil soluble to also dissolve in the water phase.

The aqueous phase also preferably comprises a water-soluble free-radical initiator as may be known to the art. The initiator can be present at up to about 20 mole percent based on the total moles of polymerizable monomers present in the oil phase. More preferably, the initiator is present in an amount of from about 0.001 to about 10 mole percent based on the total moles of polymerizable monomers in the oil phase. Suitable initiators include ammonium persulfate, potassium persulfate, hydrogen peroxide, and peroxyacetic acid.

The emulsifier is necessary for forming and stabilizing the HIPE. The emulsifier is generally included in the oil phase and tends to be relatively hydrophobic in character. An example emulsifier which functions very well is diglycerol monooleate. Other emulsifiers of this general sort also include diglycerol monomyristate, diglycerol monoisostearate, diglycerol monoesters of coconut fatty acids, sorbitan monooleate, sorbitan monomyristate, sorbitan monoesters of coconut fatty acids, sorbitan isostearate, and like compounds and mixtures thereof. U.S. Pat. No. 5,786,395 (Stone et al.) issued Jul. 28, 1998 offer further examples of these emulsifiers and is incorporated herein by reference. Such emulsifiers are advantageously added to the oil phase so that it comprises between about 1% and about 15% thereof. Obviously, emulsifiers that are particularly able to stabilize HIPEs at high temperatures are preferred. Diglycerol monooleate is exemplary in this respect.

Co-emulsifiers may also be used to provide additional control of cell size, cell size distribution, and emulsion stability. Exemplary co-emulsifiers include phosphatidyl cholines and phosphatidyl choline-containing compositions, aliphatic betaines, long chain C12-C22 dialiphatic, short chain C1-C4 dialiphatic quaternary ammonium salts, long chain C12-C22 dialkoyl(alkenoyl)-2-hydroxyethyl, short chain C1-C4 dialiphatic quaternary ammonium salts, long chain C12-C22 dialiphatic imidazolinium quaternary ammonium salts, short chain C1-C4 dialiphatic, long chain C12-C22 monoaliphatic benzyl quaternary ammonium salts, the long chain C12-C22 dialkoyl(alkenoyl)-2-aminoethyl, short chain C1-C4 monoaliphatic, short chain C1-C4 monohydroxyaliphatic quaternary ammonium salts.

Various optional ingredients may also be included in either the water or oil phase for various reasons. Examples include antioxidants (e.g., hindered phenolics, hindered amine light stabilizers, UV absorbers), plasticizers (e.g., dioctyl phthalate, dinonyl sebacate), flame retardants (e.g., halogenated hydrocarbons, phosphates, borates, inorganic salts such as antimony trioxide or ammonium phosphate or magnesium hydroxide), dyes and pigments, fluorescers, filler particles (e.g., starch, titanium dioxide, carbon black, or calcium carbonate), fibers, chain transfer agents, odor absorbers such as activated carbon particulates, dissolved polymers and oliogomers, and such other agents as are commonly added to polymers for a variety of reasons. Such additives may be added to confer color, fluorescent properties, to disperse charge, form a wettable surface on the HIPE foam struts, or for any other purpose.

According to some embodiments of the invention the compliant pad material(s) selection may include additional constraints such as the ability to heat the compliant pad during use or prior to use for example as discussed below in respect to heating a cleaning liquid, water, or proprietary cleaning solution. However, in other instances it may be beneficial to heat the compliant pad to increases its compliance, enhance release of a portion of the compliant pad such as a cleaning agent or perfume, or it's solubility in water as the compliant pad is comprised of cleaning agents held within a soluble matrix. Accordingly, the compliant pad matrix may be exposed, for example, to microwave irradiation to heat the compliant pad and other materials within the matrix and accordingly factored into the material selection for its manufacture. Optionally the compliant pad, and in some instances the consumable pad, may be heated, for example in a microwave, as part of a sanitization process to kill bacteria, germs, etc.

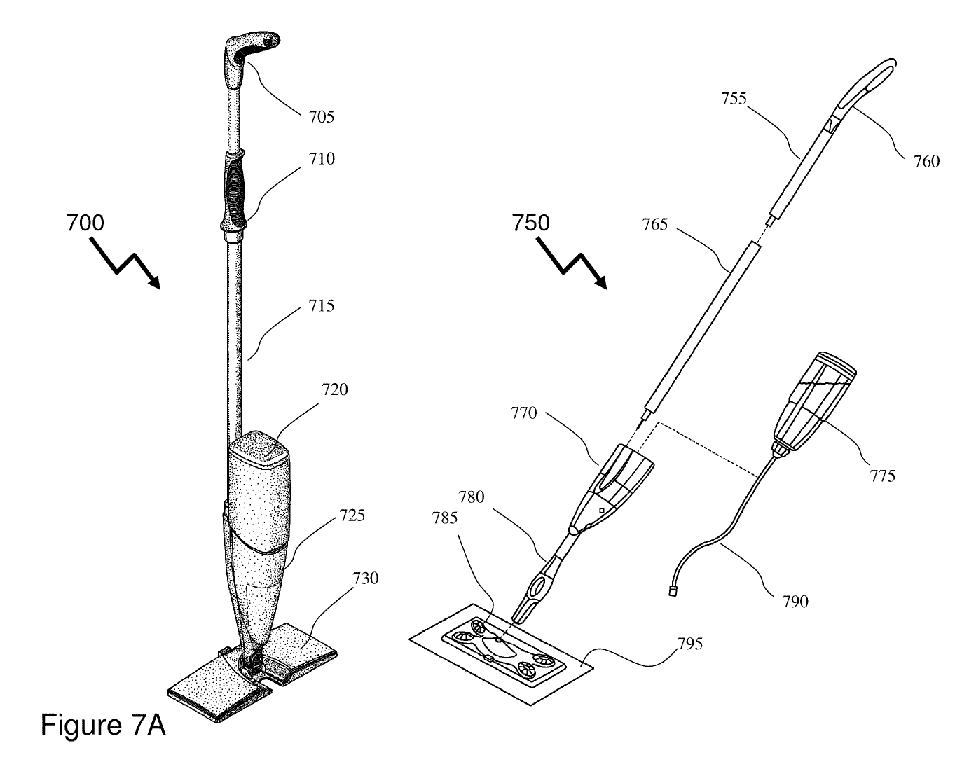

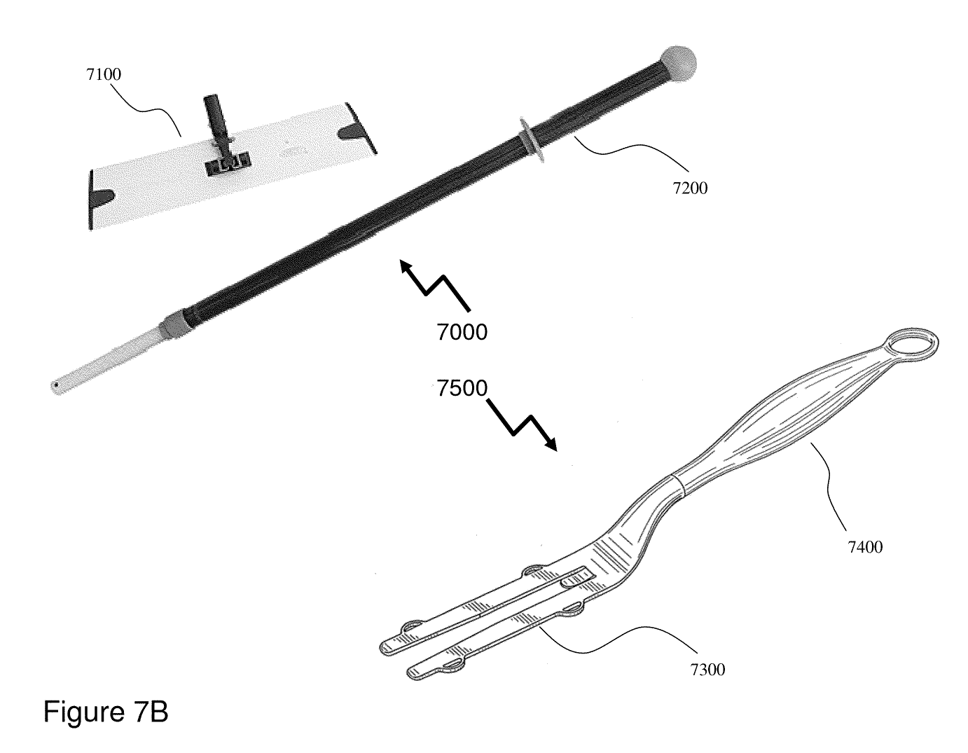

Cleaning Implement: Referring to FIG. 7A there are depicted first assembly 700 and second assembly 750 according to embodiments of the invention for cleaning a variety of surfaces including, but not limited to, baseboards, cornices, panel moldings, casings, door jambs, crown moldings, coving, picture rails and chair rails. First assembly 700 representing one embodiment of a wet cleaning implement which includes an electrically powered liquid delivery mechanism (not shown for clarity). In one embodiment, the electrically powered delivery mechanism comprises a gear pump in fluid communication with the reservoir 720 that allows extraction from either end of the reservoir 720 according to the orientation of the first assembly 700 and the liquid level within the reservoir 720. Control of the electrically powered delivery mechanism being through a variety of sensing mechanisms including but not limited to those relating to the liquid level within the reservoir 720, orientation of the first assembly 700, detection of air/liquid within extraction piping etc. The gear pump is connected to an electrical motor which is powered either by at least one battery contained within the housing 725 or via a mains electrical connection via a cable and plug, not shown for clarity. Triggering of release of the cleaning liquid or water within the reservoir 720 being through a switch contained within the handle 705 or otherwise disposed on the first assembly 700.

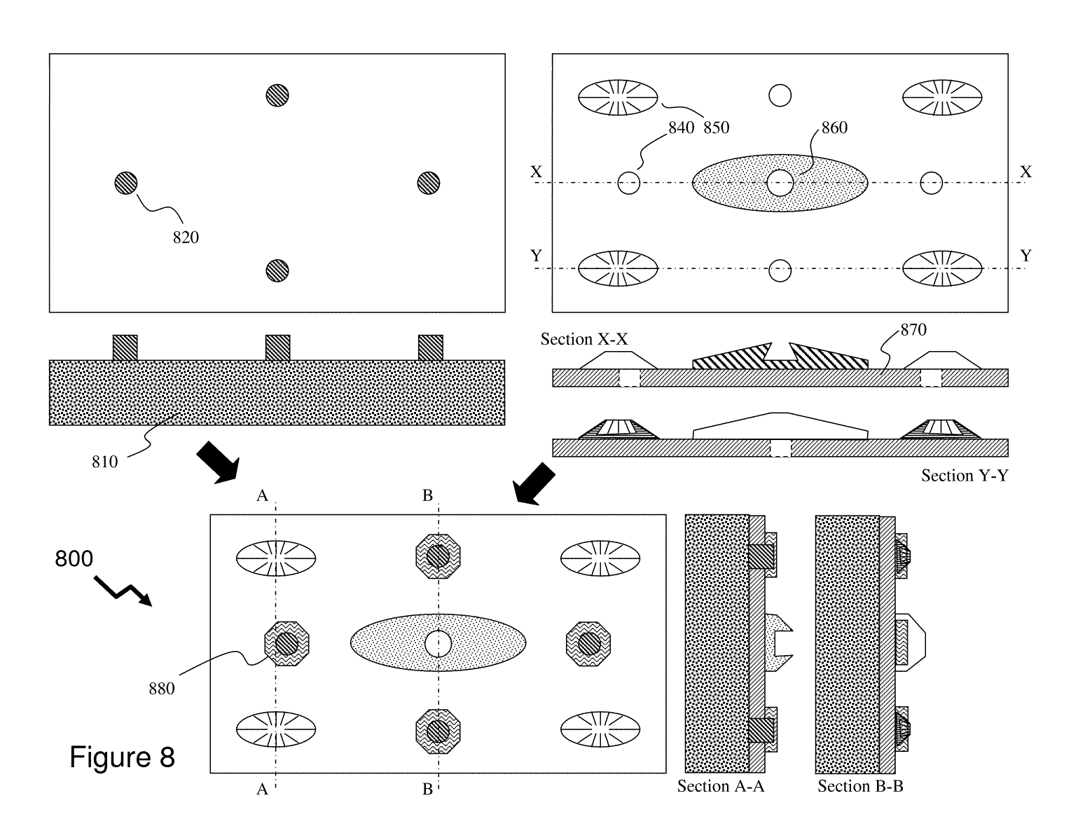

The fluid from the reservoir 720 is pumped into the compliant pad/consumable pad assembly, not shown in first assembly 700, but described below in respect of FIGS. 8 through 13 respectively. The compliant pad/consumable pad assembly being attached to frame 730 which is intended to provide a low compliance backing to the compliant pad/consumable pad assembly. The handle 705 is connected to the housing 725 via an extendable arm 715 that also comprises a grip 710. Accordingly, the user may hold the first assembly 700 through the handle 705 and grip 710 or handle 705 and extendable arm 715 for example. In this manner the user may hold first assembly 700 against the vertical surface to be cleaned wherein the compliant pad/consumable pad assembly engages the vertical surface to clean it whilst the user selectively releases fluid from the reservoir 720 when using the first assembly 700 as a wet cleaner or without release when using it as a dry cleaner. Optionally either one or both of the compliant pad and consumable pad assembly may be varied between operations in dry or wet modes. Similarly, the consumable pad and/or compliant pad may be varied according to the contours for example of the vertical surface being cleaned.

Second assembly 750 comprises a grip 760 which is connected to a housing 770 via first handle section 755 and second handle section 760. The housing 770 is then connected via base section 780 to base plate 795 that has disposed multiple pad grips 785. A detachable reservoir 775 and liquid delivery pipe 790 are also shown. Detachable reservoir 775 may for example be filled by the user with water, cleaning fluids or proprietary cleaning solutions sold by the manufacturer of the second assembly 750. The liquid delivery mechanism used within second assembly 750 may be a gravity-fed mechanism or a motorized system such as described above. Wherein the mechanism is motor based a DC brushless motor may be employed for high efficiency, simplicity of design, reliability, and extended battery life (where a battery is employed). Optionally detachable reservoir 775 may be sold by the manufacturer wherein attachment of the liquid delivery pipe 790 pierces a seal thereby removing the requirement for the user to directly handle the cleaning fluids.

Alternatively, the liquid delivery pipe may be omitted and the reservoir 775 directly inserted into the housing 770, wherein it a seal may optionally be pierced to reduce spillage etc. An advantage of second assembly 750 is that the multiple pieces allow for it to be broken down such that it may be sold at retail in a kit format with reduced shelf space. In some embodiments of the invention it may be beneficial to heat the cleaning fluid, water or proprietary cleaning solutions, for example to improve their efficiency or particular characteristics of them such as miscibility with water, effervescence, etc. Accordingly, the cleaning implement may include, for example, a heated reservoir, a heating element within the liquid delivery mechanism, a heated section in the cleaning implement itself, or a heating mechanism heating the compliant pad. In other instances the liquid may be applied to one or both of the compliant pad and consumable pad by the user directly and the liquid heated by microwaving the one or both of the compliant pad and consumable pad prior to attachment to the cleaning implement or in instances where the cleaning implement is compact in a stored or normal state and made from suitable materials the entire assembly.

Referring to FIG. 7B there are depicted third and fourth assemblies 7000 and 7500 respectively representing other embodiments of the invention. Third assembly 7000 comprises a handle 7200 and base 7100 which is demountably attached. Third assembly thereby may operate with dry or wet compliant pad and/or consumable pad assemblies according to embodiments of the invention as described below in respect of FIGS. 8 through 13. Fourth assembly 7500 as depicted comprises a handle 7400 and mounting frame 7300 wherein a dry or wet compliant pad and/or consumable pad assembly may be attached to the prongs of the mounting frame 7300. In all cases the essential features of the assemblies being to allow the user to position and maintain the dry or wet compliant pad and/or consumable pad assemblies against the surface being cleaned and move them along these surfaces to clean them with ease.

Compliant Pad Attachment: As described above in respect of FIGS. 7A and 7B cleaning assemblies for attaching dry or wet compliant pad and/or consumable pad assemblies according to embodiments of the invention are presented. These cleaning assemblies may hold the compliant pad as fixed or removable from the assembly whereas the consumable pad is removable in both instances. The compliant pad may by virtue of being replaced less frequently than the consumable pads be attached with a different mechanism. According to some embodiments of the invention the compliant pad may have an attachment means integral to it or the attachment means may be an integral part of the handle of the cleaning implement or may be removably attached to the end of the handle. Amongst attachment means that may be exploited the following represent a non-exhaustive list of examples that include a friction fit means, a clamping means, a threaded screw means, by hook and loop attachment or by any other suitable attachment means. FIG. 8 as described below presents a threaded screw means of attaching the compliant pad to the cleaning implement.

The compliant pad may have a rigid or flexible plastic or metal fitment for attachment to the cleaning implement or the cleaning pad may be directly attached to the cleaning implement. It would be evident to one skilled in the art that the compliant pad by virtue of being attached to the cleaning implement in a rigid manner allows the user to apply pressure to the compliant pad against the surface being cleaned via the cleaning implement. It would also be apparent that in addition to the cleaning implements presented above in respect of FIGS. 7A and 7B that the compliant pad may be mounted to a variety of other cleaning implements known within the prior art either for the sole purpose of cleaning surfaces with contours including but not limited to those outlined above or as part of a cleaning implement designed to clean these surfaces and other surfaces such as flooring, including wood, tile and carpet. Accordingly, the compliant pad may be disposed on the cleaning implement in a fixed position for use or disposed upon an element of the cleaning implement that may be moved from a first position to at least a second position wherein in one position the compliant pad engages the surface to be cleaned and in the other position is disengaged or stored.

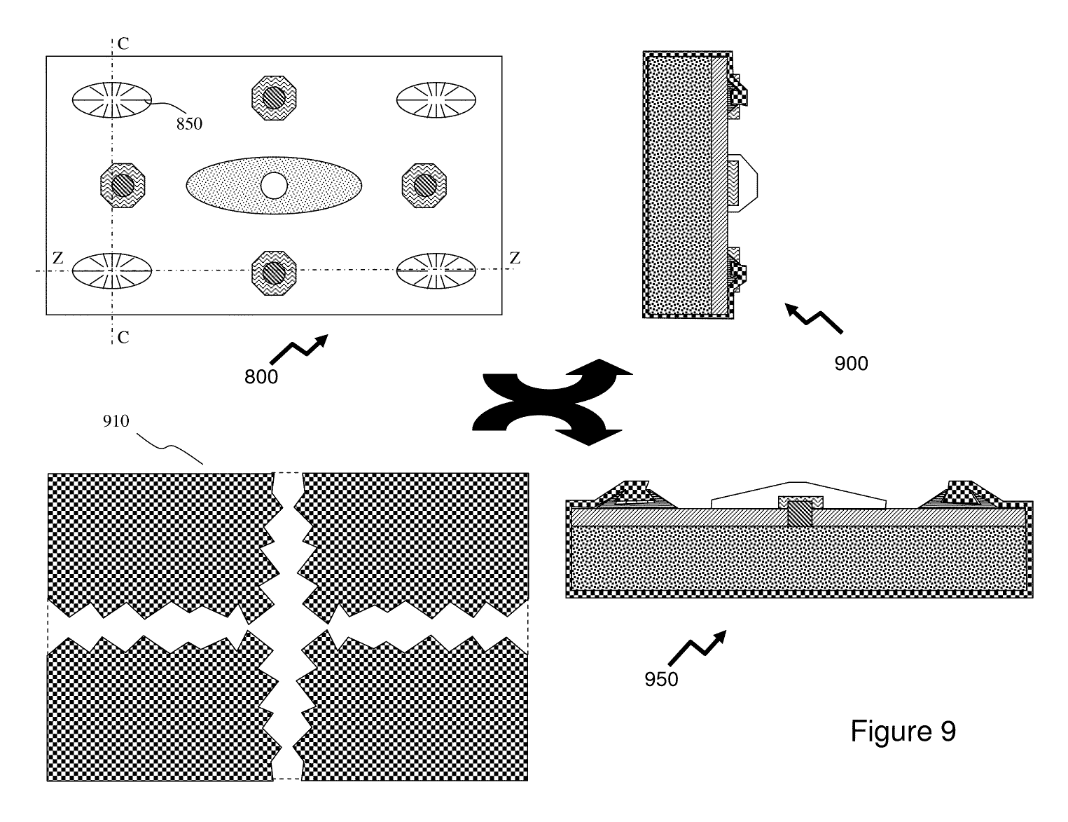

Referring to FIG. 8 a first assembly 800 of compliant pad 810 and cleaning implement, represented by baseplate 870 is presented. Accordingly, the compliant pad 810 has disposed upon its surface a plurality of posts 820. These may be inserted into the body of the compliant pad 810 for example or be attached to a thin backing to which the compliant pad is attached. According to embodiments of the invention the posts 820 may be threaded, unthreaded, or have other features that form part of their attachment means to the cleaning implement. Also shown is baseplate 870 that has a central attachment means 860 for the demountable attachment of a handle, allowing collapsed storage, shipping etc of the cleaning implement. Also formed within the baseplate 870 are openings 840 that have dimensions and pattern to allow the insertion of the posts 820 on the complaint pad 810 to be inserted through. As shown in first assembly 800 attachments 880 engage with the posts 820 thereby retaining the compliant pad 810 to the baseplate 870. Also shown on baseplate 870 are finger grip structures 850, the purpose of which is described below in respect of FIG. 9.

First and second cross-sections X-X and Y-Y are shown for the baseplate 870 whilst third and fourth cross-sections A-A and B-B of first assembly 800 depict the resulting assembly of the baseplate 870 and the complaint pad 810. The compliant pad 810 being formed from a compliant material, such as HIPE for example, whilst baseplate 870 being formed from a resilient material so that pressure applied to the baseplate 870 from the user through pushing the handle of the cleaning implement is transferred to the compliant pad 810.

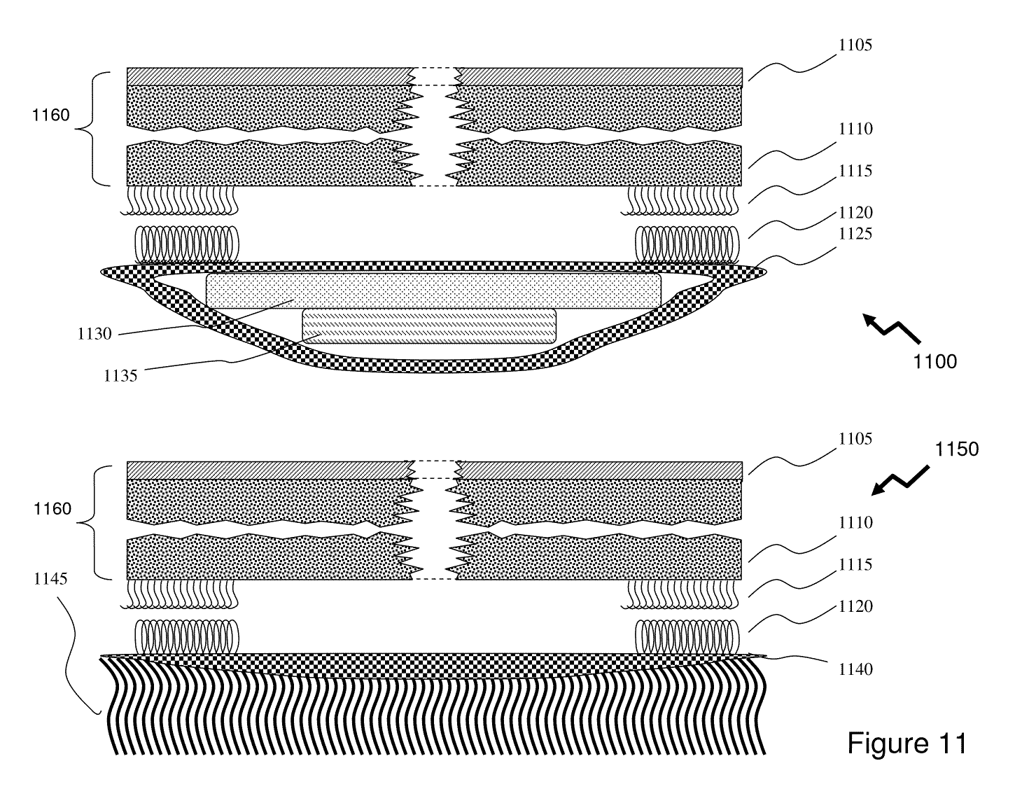

Referring to FIG. 9 there are depicted first and second sectional assemblies 900 and 950 respectively wherein the first assembly 800 is assembled with the consumable, i.e. disposable, pad 910. Accordingly as shown the consumable pad 910 is wrapped over the first assembly 800 and parts of the consumable pad 910 are pushed into the finger grip structures 850 such that they restrain the consumable pad 910 in place. Construction of the consumable pad 910 will be described below in respect of FIGS. 11 through 13.

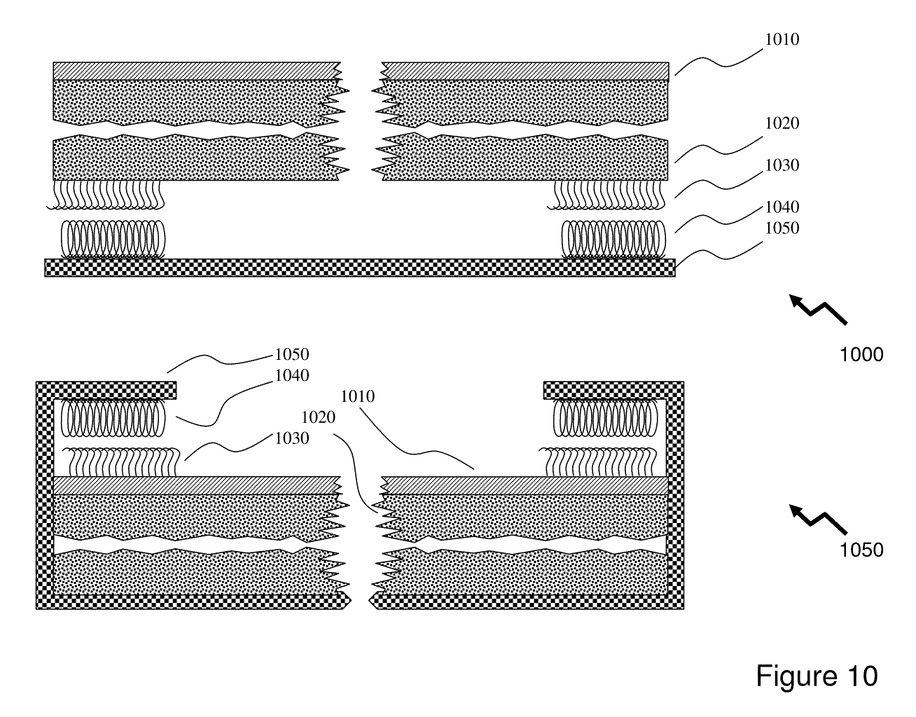

Referring to FIG. 10 first and second attachment schematics 1000 and 1050 depicting alternative attachment means for a consumable pad 1050 to a baseplate for a cleaning implement comprising plate 1010 and compliant pad 1020. Referring to first attachment schematic 1000 a predetermined region of the lower surface of the compliant pad 1020 has formed thereupon a plurality of hooks 1030. Likewise a predetermined region of the upper surface 1040 of the consumable pad 1050 has a plurality of loops 1040. When brought together the hooks 1030 on the compliant pad 1020 engage the loops 1040 of the consumable pad 1050 thereby attaching the consumable pad 1050 to the compliant pad 1020. Once the user has been cleaning the consumable pad 1050 becomes dirty and requires replacement, wherein the user pulls the dirty consumable pad 1050 off the compliant pad 1020 and replaces it with a clean consumable pad 1050. As evident from the discussions below in respect of FIGS. 11 through 13 the consumable pad 1050 may vary in construction according to the requirements of the user.

Now referring to second attachment schematic 1050 the hooks 1030 are disposed on the plate 1010 such that the user wraps the consumable pad 1050 around the compliant pad 1020 and plate 1010 such that the loops 1040 on the consumable pad 1050 attach on the upper side of the plate 1010 to the hooks 1030. It would be evident to one skilled in the art that other methods of attaching the consumable pad 1050 to the baseplate of the cleaning implement, either to resilient plate such as plate 1010 or compliant element such as compliant pad 1020.

Consumable Pad: Referring to FIG. 11 first and second schematics 1100 and 1150 respectively are shown for embodiments of the consumable pad such as consumable pad 1050 and consumable pad 910 in FIGS. 10 and 9 respectively. A wide variety of materials can be used as the consumable pad. The consumable pad should have sufficient wet strength, abrasivity, loft and porosity to provide the desired cleaning action on the surfaces. Examples of suitable consumable pads include, nonwoven consumable pads, woven consumable pads, hydroentangled consumable pads, foams and sponges. As will be evident from the descriptions below the materials, construction, abrasion, wet strength, wet/dry contact nature, absorbency, and other aspects of the consumable pad can be varied over a wide range without departing from the scope of the invention.

Considering first schematic 1100 then there is depicted a baseplate 1160 for a cleaning implement comprising back plate 1105 and compliant pad 1110. For sake of the embodiment the compliant pad 1110 is depicted with hooks 1115 and consumable pad body 1125 depicted with loops 1120 although it would be evident that other attachment means may be employed without departing from the scope of the invention. Within consumable pad 1125 are fluid pad 1130 and solvent pad 1135 wherein when the overall assembly is pushed against a surface to be cleaned fluid pad 1130 releases a fluid, for example water, that acts as a carrier for the solvent within the solvent pad 1135 such that this soaks into the consumable pad 1125 and acts upon the surface being cleaned.

It would be evident that consumable pad 1125 may alternatively be formed from an upper layer that engages the compliant pad 1110 and a lower layer that engages the surface being cleaned. Accordingly the properties of these layers may be varied such as having upper layer act a fluid barrier whilst lower layer acts to allow the fluid to pass through.

Referring to second schematic 1150 a consumable pad 1140 is depicted engaging with the compliant pad 1110. Consumable pad 1140 now being an essentially planar layer of material that has a plurality of fibers 1145 disposed across the surface opposite that with the loops 1120. Accordingly, the plurality of fibers 1145 allow penetration into elements of surfaces being cleaned that have high aspect ratio.

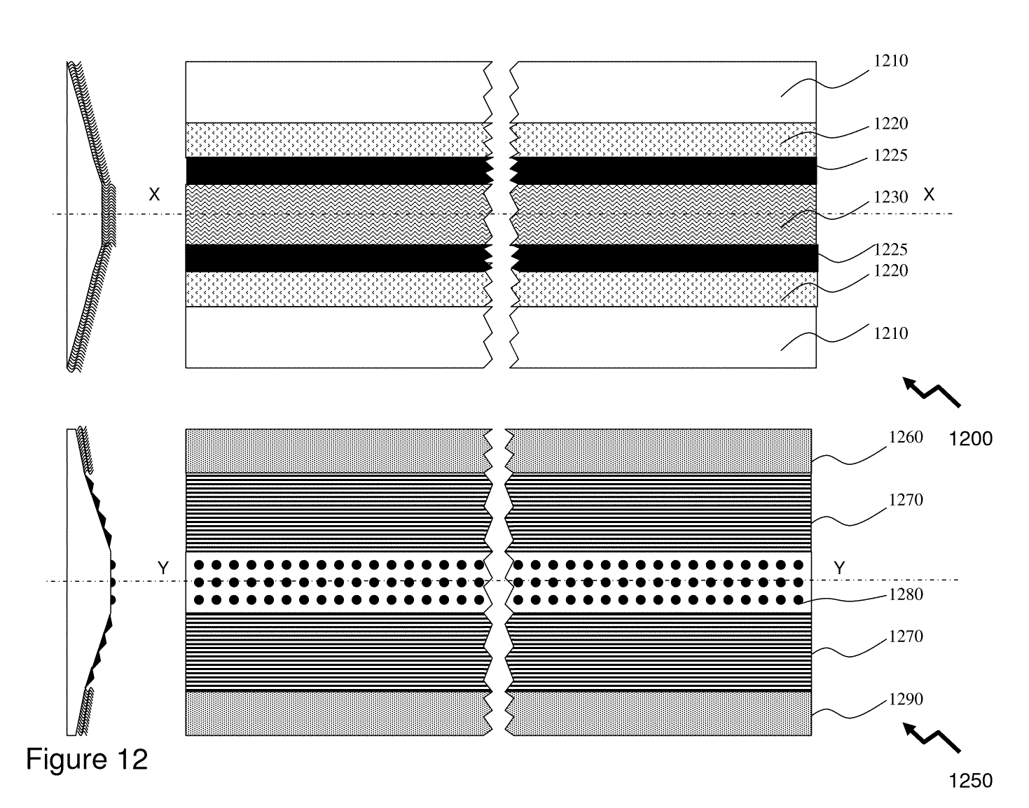

Now referring to FIG. 12 there are depicted first and second schematics 1200 and 1250 respectively of consumable pads according to embodiments of the invention. Considering first schematic 1200 the view is towards what would be the consumable pad surface contacting the surfaces to be cleaned. As shown the consumable pad comprises 7 regions with vertical symmetry relative to axis X-X of the consumable pad such that the user in attaching the pad does not have to concern themselves with orientation. As shown there are first pad regions 1210, second pad regions 1220, third pad regions 1225 and fourth pad region 1230. Each region may provide a different characteristic in the cleaning process and may within the construction of the consumable pad also be acting in conjunction with different elements that form the internal structure of the consumable pad.

Accordingly, for example, first regions 1210 may be essentially formed from a material providing high dust retention through a plurality of short fibers, whilst second regions 1220 are formed from a material having high absorbency to reduce leeching of fluid released by the third regions 1225 into the intended dry region of the first regions 1210. As such third regions 1225 have an internal structure formed from a material with high fluid retention. Fourth region has an internal structure formed from a material compatible with retaining a solvent. In addition to their internal structure these regions may further vary in surface texture. For example whilst first to third regions 1210, 1220 and 1225 respectively may be relatively similar in being formed with short fibers the fourth region 1230 may be formed with long fibers.

Now referring to second schematic 1250 a different consumable pad is depicted with the consumable pad now comprising five bands symmetrically disposed about the axis Y-Y of the consumable pad. As such there are first regions 1260, second regions 1270, and third region 1280. The consumable pad depicted in second schematic 1250 is intended for a different cleaning action to that of first schematic 1200 and hence whilst internal elements may be common or different the surface of the consumable pad is intended to provide different cleaning characteristics. As such first regions 1260 may be formed from a material providing high dust retention whilst second regions 1270 are formed from a material having a series of short ridges formed from a resilient material to provide a slightly abrasive surface to the consumable pad such that difficult to clean areas of the surfaces can be agitated more aggressively. Finally third region 1280 comprises a plurality of compliant bumps formed onto the surface of the consumable pad.

It would be evident to one skilled in the art that the materials employed in forming the surface texture of the consumable pads described above may be different within each region, the same within each region, or be formed from a common starting material that is processed differently during the fabrication sequence of the consumable pad.

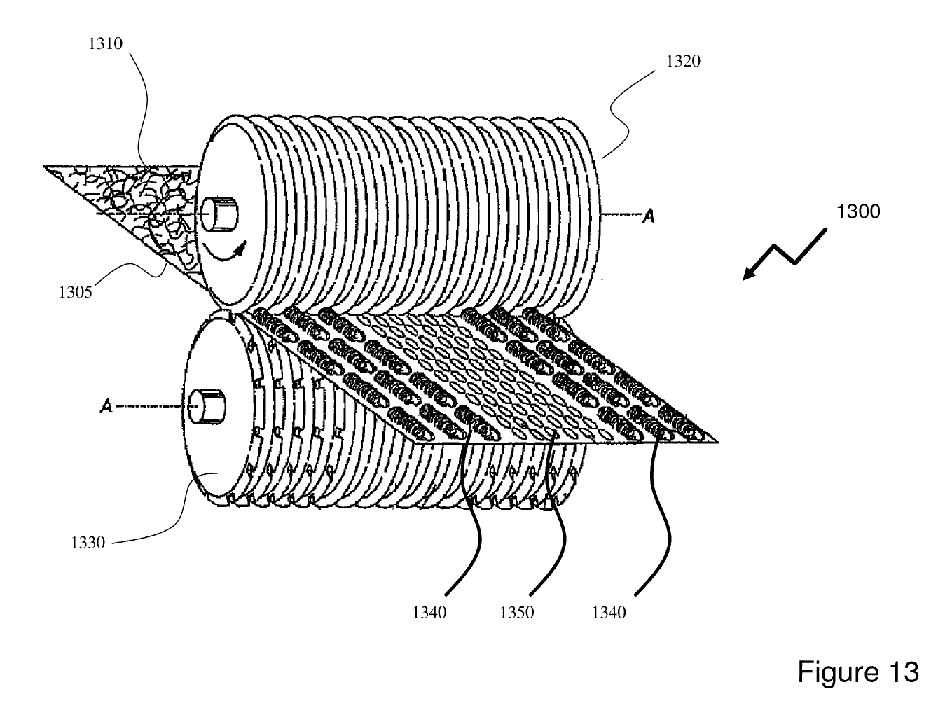

Referring to FIG. 13 there is depicted a system 1300 for forming the surface of the consumable pad according to an embodiment of the invention. Cleaning layer 1305 may be formed, formed for example from a generally planar, two dimensional nonwoven precursor web 1310 on system 1300, the apparatus may be oriented for continuous web processing with respect to both the direction of travel (DoT) of the precursor web 1310 and a cross direction, essentially perpendicular to the direction of travel (PDoT), as is known in the art of nonwoven webs. Precursor web 1310 has formed therein in predetermined regions a plurality of melt-weakened portions prior to entering the nip region of system 1300 between the upper roller 1320 and lower roller 1330. Melt-weakened portions are formed in predetermined regions of web 1310 by thermal point processing in the predetermined regions, the predetermined regions corresponding to first regions 1340 and second region 1350.

According to the requirements of the consumable pad the melt-weakened portion of the predetermined region may be generally elongated and/or oriented in the DoT such as in first regions 1340. In other instances, physical stretching in the PDoT in the system 1300 corresponding to the second region 1350, the melt-weakened portions may rupture to form apertures within the cleaning layer 1305. Accordingly, the design of upper and lower rollers 1320 and 1330 respectively, either solely or in conjunction with localized temperature variations, controlled environments and fiber material variations can be utilized to form a continuous strip of material from which consumable pads could be subsequently cut, for example with a hot air knife to seal the ends of the consumable pad as cut.

By combining the surface profiles such as described supra in FIGS. 11 and 12 with cross-sectional variations the cleaning layer 1305 of the consumable pad of the present invention provides for significant cleaning and fluid handling benefits over prior art cleaning pads.

One advantage of the system 1300 described above is that the cleaning layer 1305 can be produced in-line with other production equipment on a manufacturing line for producing such articles. For example, a system 1300 such as disclosed above, can be made as a unit operation for an existing manufacturing line. As a unit operation, such system 1300 can be modular, so that it can be easily changed out. When used as part of a manufacturing line for consumable pads, the upper and lower rollers 1320 and 1330 respectively need not be much wider than the product itself, thereby providing for relatively easy installation and removal. As discussed above various patterns for the regions of the consumable pad can therefore be implemented with a minimum interruption.

It would be evident to one skilled in the art that the structure of a consumable pad in conjunction with a compliant pad may be varied. According to embodiments of the invention the compliant pad may comprise fluid filled pockets, be composed of water soluble foam to controllably release cleaning chemicals through controlled release from a reservoir or immersion, spraying etc, comprise fluid retaining polymer matrix, etc such that during use the compliant pad is partially consumed such that after use with a number of consumable pads the compliant pad would be replaced. Within the embodiments presented above there is depicted a one to one association of the compliant pad to consumable pads. However, it would be evident that rather than the user attaching the consumable pad to the compliant pad that in some embodiments a plurality of consumable pads may be pre-attached to the compliant pad such that the user simply removes a consumable pad after use.

Within the descriptions of embodiments of the invention the term compliant pad has been used to refer to the element engaging directly the surface to be cleaned. According to some embodiments of the invention wherein the structure of the compliant pad is relatively simple and planar it may be referred to or conceptualized as a sheet rather than a pad. In other embodiments of the invention the profile of the consumable pad may be substantially planar with only surface texturing rather than containing multiple different materials with differing properties.

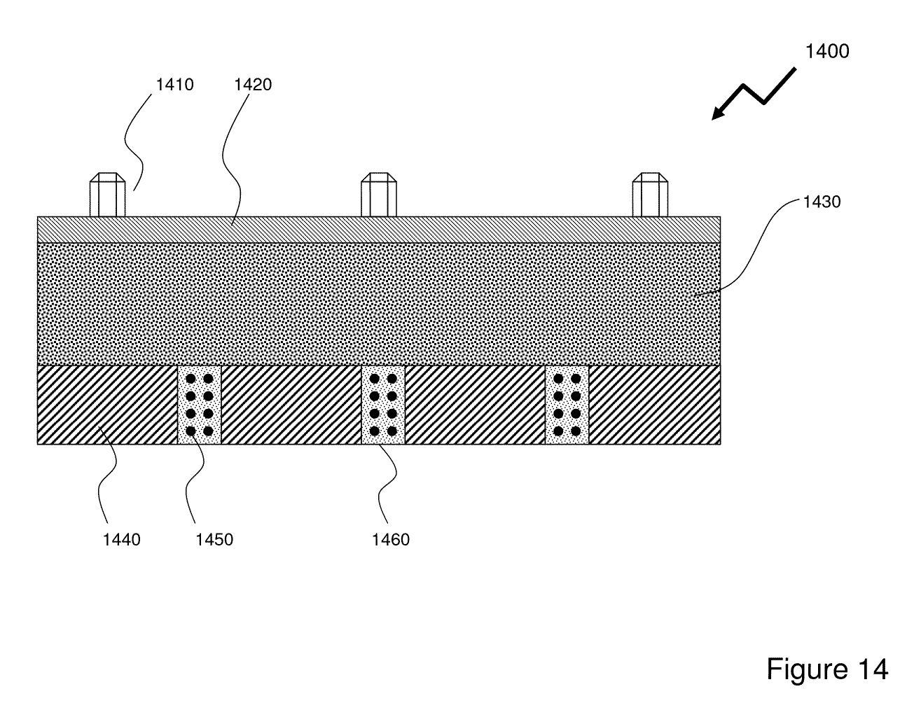

Within embodiments of the invention the compliant pad has generally been depicted as a single element. However, it would be evident from FIG. 14 that the structure of the compliant pad may be more complex according to the overall cleaning system implemented and partitioning of chemicals, perfumes, solvents etc between the consumable pad and the compliant pad.

Accordingly compliant pad 1400 is depicted as comprising:
plurality of threaded posts 1410 for attaching the compliant pad 1400 to the cleaning implement;
resilient plate 1420 to which the threaded posts 1410 are attached or formed with to transfer pressure of user from cleaning implement across the complaint pad 1400;
compliant matrix 1430 providing the ability for the compliant pad to conform approximately to the structure being cleaned, and hence formed from a compliant foam or similar material;
cleaning matrix 1440 providing controlled release of a solvent or solvents for use in the cleaning process wherein these are released under mechanical action or action from a fluid within the consumable pad allowing them to be applied to the surface being cleaned; and
encapsulant matrix 1450 providing a matrix within which fragrance receptacles 1450 can be hosted allowing controlled release of a fragrance during the cleaning process either for an immediate impact to the user or for time based release wherein the fragrance receptacles 1450 are transferred during the surface being cleaned and subsequently release the fragrance, and wherein encapsulant matrix 1450 may itself provide some released solvent/cleaning agent during the cleaning process.

It would be evident to one skilled in the art that the compliant pad 1400 may be comprised of multiple elements which may be across the full area of the compliant pad 1400 or may be disposed in a predetermined pattern across the area of the compliant pad 1400. It would also be evident that where a cleaning matrix, such as cleaning matrix 1440 is provided that release of a chemical, solvent, cleaning agent etc may be triggered through mechanical action of the user cleaning, through water based dissolution of a component of the cleaning matrix 1440, or release of another chemical or solvent from the attached compliant pad which may be “dry-to-the-touch” but release fluid under compression/mechanical action.

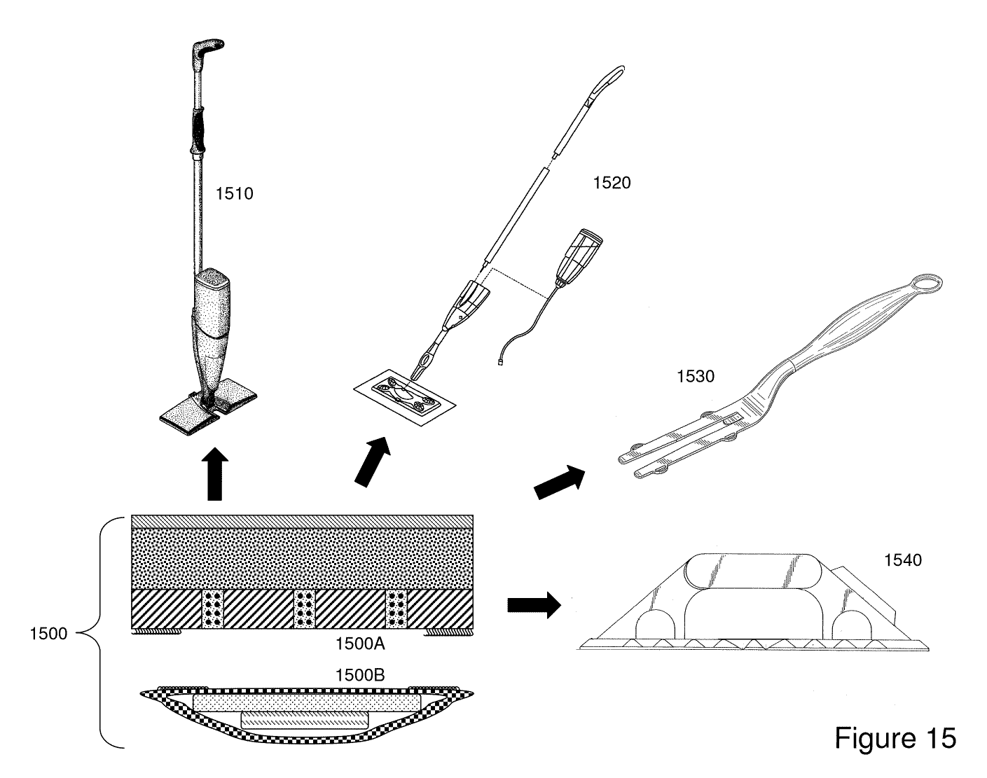

Referring to FIG. 15 there is depicted a cleaning assembly 1500 according to an embodiment of the invention comprising compliant pad 1500A and consumable pad 1500B wherein the cleaning assembly 1500 may be used with a variety of cleaning implements including but not limited to:
first cleaning implement 1510, such as first assembly 700 in FIG. 7A
second cleaning implement 1520, such as second assembly 750 in FIG. 7A;
third cleaning implement 1530, such as second assembly 7500 in FIG. 7B; and
fourth cleaning implement 1540, such as a variant of the prior art of B. Johnson in U.S. Pat. No. 4,893,369.

It would be evident that use of a compliant pad and/or consumable pad comprising water soluble elements may be used in conjunction with cleaning implements such as first and second cleaning implements 1510 and 1520 in FIG. 15 wherein the water for dissolving the matrix to release the solvent(s) and/or cleaning agent(s) may be provided from these rather than relying upon or requiring water within either of the compliant pad and/or consumable pad.

Optionally, embodiments of the invention may be provided wherein only a compliant pad is employed during a first stage of a cleaning process and a subsequent pad, which may be a consumable pad, is used in a second stage of the cleaning process.

Water-Soluble or Water-Dispersible Foam Pads: The consumable pad and/or compliant pad may comprise a water-soluble or water-dispersible foam. The foam component may comprise a mixture of a polymeric material and a cleaning composition, the foam component being stable upon contact with air and unstable upon contact with water. The foam component may release the cleaning composition or part thereof upon contact with water, the component preferably partially or completely disintegrating, dispersing, denaturing and/or dissolving upon contact with water.

The foam and cleaning composition matrix may comprise an interconnected network of open and/or closed cells. Any polymeric material, which can be formed into an air-stable, water-unstable foam, can be used in the foam component and can be used to form the matrix or part thereof, of the foam component. The polymeric material may be a water-dispersible or a water-soluble polymer.

Suitable polymers are selected from cationic polymers, such as quaternary polyamines, polyvinyl alcohols, polyvinyl pyrrolidone, polyalkylene oxides, cellulose, polysaccharides, polycarboxylic acids and salts, polyaminoacids or peptides, polyamides, polyacrylamide, or derivatives or copolymers thereof. Suitable polymers are selected from polyvinyl alcohols, cellulose ethers and derivatives thereof, copolymers of maleic/acrylic acids, polysaccharides including starch and gelatine, natural gums such as xanthum and carragum. Copolymers block polymers and graft polymers of the above can also be used. Mixtures of polymers can also be used. Copolymers or mixtures of polymers may provide control of the mechanical and/or dissolution properties of the foam component, depending on the application thereof and the required needs. The polymer may have any average molecular weight from about 1000 to 1,000,000; or even from 4000 to 250,000 or even form 10,000 to 200,000 or even form 20,000 to 75,000.

Water-Soluble or Water-Dispersible Pocket Pads: The consumable pad and/or compliant pad may comprise a water-soluble or water dispersible pocket(s) or container(s). Suitable containers are water-soluble or water-dispersible gelatin beads, comprising cleaning compositions completely surrounded by a coating made from gelatin. The consumable pad and/or compliant pad may comprise a water-soluble or water-dispersible pocket. The pocket is typically a closed structure, made of a water-soluble or water-dispersible film described herein, enclosing a volume space which comprises a composition. Said composition may be in solid, gel or paste form. The pocket can be of any form, shape and material which is suitable to hold the composition, e.g., without allowing the release of the composition from the pocket prior to contact of the pocket with water. The exact execution will depend on for example, the type and amount of the composition in the pocket, the number of compartments in the pocket, the characteristics required from the pocket to hold, protect and deliver or release the composition. The pocket may be made from a water-soluble or water-dispersible film. Suitable water-soluble films are polymeric materials, preferably polymers which are formed into a film or sheet. The material in the form of a film can, for example, be obtained by casting, blow-molding, extrusion or blow extrusion of the polymer material, as known in the art.

Suitable polymers, copolymers or derivatives thereof are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. Suitable polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates. Suitable polymers are selected from polyvinyl alcohols, polyvinyl alcohol copolymers and hydroxypropyl methyl cellulose (HPMC). The polymer may have any weight average molecular weight from about 1000 to 1,000,000; or even from 10,000 to 300,000 or even from 15,000 to 200,000 or even from 20,000 to 150,000.

Also useful are polymer blend compositions, for example comprising a hydrolytically degradable and water-soluble polymer blend such as polylactide and polyvinyl alcohol, achieved by the mixing of polylactide and polyvinyl alcohol, typically comprising 1-35% by weight polylactide and approximately from 65% to 99% by weight polyvinyl alcohol, if the material is to be water-dispersible, or water-soluble.

Suitable water-soluble films are films which comprise PVA polymers. The water-soluble film herein may comprise other additive ingredients than the polymer or polymer material. For example, it may be beneficial to add plasticisers, for example glycerol, ethylene glycol, diethyleneglycol, propylene glycol, sorbitol and mixtures thereof, additional water, disintegrating aids. It may be useful that the pocket or water-soluble film itself comprises a cleaning additive.

Non-Woven Pads: According to embodiments of the invention the consumable pad and/or compliant pad may be composed of nonwoven fibers or paper, see for example “Nonwoven Fabrics Handbook” (Assoc. Nonwoven Fabric Industry) and ISO 9092-EN-029092 respectively for generally accepted definitions. The definitions of both nonwoven and paper consumable pad and/or compliant pads do not include woven fabric or cloth or sponge. The consumable pad and/or compliant pad can be partially or fully permeable to water. The consumable pad and/or compliant pad can be flexible and the consumable pad and/or compliant pad can be resilient, meaning that once applied external pressure has been removed the consumable pad and/or compliant pad regains its original shape.

Methods of making nonwovens are well known in the art. Generally, these nonwovens can be made by air-laying, water-laying, melt blowing, coforming, spun bonding, or carding processes in which the fibers or filaments are first cut to desired lengths from long strands, passed into a water or air stream, and then deposited onto a screen through which the fiber-laden air or water is passed. The resulting layer, regardless of its method of production or composition, is then subjected to at least one of several types of bonding operations to anchor the individual fibers together to form a self-sustaining consumable pad and/or compliant pad. In the present invention the nonwoven consumable pad and/or compliant pad can be prepared by a variety of processes including, but not limited to, air-entanglement, hydroentanglement, thermal bonding, and combinations of these processes.

Additionally, the first layer and the second layer, as well as additional layers, when present, can be bonded to one another in order to maintain the integrity of the article. The layers can be heat spot bonded together or using heat generated by ultrasonic sound waves. The bonding may be arranged such that geometric shapes and patterns, e.g. diamonds, circles, squares, etc. are created on the exterior surfaces of the layers and the resulting article.

The bonding pattern can be chosen in order to maximize stiffness of the consumable pad and/or compliant pad. This applies in particular when bonding is effected by adhesive (chemical, such as epoxy resin adhesive, or other adhesive) or by ultrasound. Thermal or pressure bonding can be used if the layers to be bonded are appropriate for this as well as use of adhesive or ultrasonic bonding across the full area of the consumable pad and/or compliant pad.

One suitable application pattern for adhesive, ultrasonic or other bonds is in the form of a number of stripes extending across the width of the consumable pad and/or compliant pad. Preferably the stripes are parallel. The direction can be chosen depending upon the direction in which stiffness is required. For instance, if stiffness in the machine direction (this direction being defined in relation to the manufacturing process for the consumable pad and/or compliant pad) is required, i.e. it is required to make folding along a line extending in the transverse direction more difficult, then the stripes can extend in the machine direction. Conversely, if transverse direction stiffness is required, then stripes extending in the transverse direction can be provided. A particularly bonding pattern is one of two sets of parallel stripes at different angles, for instance in cross-hatch form. Such systems can provide the effect of introduction of a net between two layers.

Such patterns can alternatively be applied using hot melt polymer printed onto the consumable pad and/or compliant pad, either between layers or on an exterior surface of one of the layers. Such patterns can be applied using any low melting polymer which is flexible after application and drying and capable of producing a continuous film. Suitable polymers include polyethylene. Application of hot melt polymer can be for instance by screen or gravure printing. Screen printing is preferred. Application of hot melt polymer can be on an exterior surface on one of the layers.

Bonding can be effected after all layers intended to form the consumable pad and/or compliant pad have been assembled. In some embodiments, however, two or more layers can be pre-bonded prior to contacting these layers with additional layers to form the consumable pad and/or compliant pad.

The cleaning consumable pad and/or compliant pads can be provided dry, pre-moistened, or impregnated with cleaning composition, but dry-to-the-touch. In one aspect, dry cleaning consumable pad and/or compliant pads can be provided with dry or substantially dry cleaning or disinfecting agents coated on or in the multicomponent multilobal fiber layer. In addition, the cleaning consumable pad and/or compliant pads can be provided in a pre-moistened and/or saturated condition. The wet cleaning consumable pad and/or compliant pads can be maintained over time in a sealable container such as, for example, within a bucket with an attachable lid, sealable plastic pockets or bags, canisters, jars, tubs and so forth. Desirably the wet, stacked cleaning consumable pad and/or compliant pads are maintained in a resealable container. The use of a resealable container is particularly desirable when using volatile liquid compositions since substantial amounts of liquid can evaporate while using the first consumable pad and/or compliant pads thereby leaving the remaining consumable pad and/or compliant pads with little or no liquid. The cleaning consumable pad and/or compliant pads can be incorporated or oriented in the container as desired and/or folded as desired in order to improve ease of use or removal as is known in the art. The cleaning consumable pad and/or compliant pads of the present invention can be provided in a kit form, wherein a plurality of cleaning consumable pad and/or compliant pads and a cleaning tool are provided in a single package.

The consumable pad and/or compliant pad can include both natural and synthetic fibers. The consumable pad and/or compliant pad can also include water-soluble fibers or water-dispersible fibers, from polymers described herein. The consumable pad and/or compliant pad can be composed of suitable unmodified and/or modified naturally occurring fibers including cotton, Esparto grass, bagasse, hemp, flax, silk, wool, wood pulp, chemically modified wood pulp, jute, ethyl cellulose, and/or cellulose acetate. Various pulp fibers can be utilized including, but not limited to, thermomechanical pulp fibers, chemi-thermomechanical pulp fibers, chemi-mechanical pulp fibers, refiner mechanical pulp fibers, stone groundwood pulp fibers, peroxide mechanical pulp fibers and so forth.

Suitable synthetic fibers can comprise fibers of one, or more, of polyvinyl chloride, polyvinyl fluoride, polytetrafluoroethylene, polyvinylidene chloride, polyacrylics such as ORLON®, polyvinyl acetate, Rayon®, polyethylvinyl acetate, non-soluble or soluble polyvinyl alcohol, polyolefins such as polyethylene (e.g., PULPEX®) and polypropylene, polyamides such as nylon, polyesters such as DACRON® or KODEL®, polyurethanes, polystyrenes, and the like, including fibers comprising polymers containing more than one monomer.

The polymers suitable for the present invention include polyolefins, polyesters, polyamides, polycarbonates, polyurethanes, polyvinylchloride, polytetrafluoroethylene, polystyrene, polyethylene terephathalate, biodegradable polymers such as polylactic acid and copolymers and blends thereof. Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene, and blends thereof, polybutylene, e.g., poly(1-butene) and poly(2-butene); polypentene, e.g., poly(1-pentene) and poly(2-pentene); poly(3-methyl-1-pentene); poly(4-methyl 1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include polyethylene terephthalate, polytrimethylene terephthalate, polybutylene terephthalate, polytetramethylene terephthalate, polycyclohexylene-1,4-dimethylene terephthalate, and isophthalate copolymers thereof, as well as blends thereof.

It may be desirable that the particular polymers used for the different components of the fibers in the practice of the invention have melting points different from one another. This is important not only in producing crimped fibers but also when through-air bonding is used as the bonding technique, wherein the lower melting polymer bonds the fibers together to form the fabric or web. In some embodiments it is desirable that the lower melting point polymers make up at least a portion of the outer region of the fibers. More particularly, the lower melting component should be located in an outer portion of the fiber so that it comes in contact with other fibers. For example, in a sheath/core fiber configuration, the lower melting point polymer component should be located in the sheath portion. In a side-by-side configuration, the lower melting point polymer will inherently be located on an outer portion of the fiber.

The cleaning consumable pad and/or compliant pad of this invention may be a multilayer laminate and may be formed by a number of different techniques including but not limited to using adhesive, needle punching, ultrasonic bonding, thermal calendering and through-air bonding. The consumable pad and/or compliant pad can comprise solely naturally occurring fibers, solely synthetic fibers, or any compatible combination of naturally occurring and synthetic fibers.

The fibers useful herein can be hydrophilic, hydrophobic or can be a combination of both hydrophilic and hydrophobic fibers. As indicated above, the particular selection of hydrophilic or hydrophobic fibers depends upon the other materials included in the absorbent (and to some degree) the scrubbing layer described hereinafter. Suitable hydrophilic fibers for use in the present invention include cellulosic fibers, modified cellulosic fibers, rayon, cotton, and polyester fibers, such as hydrophilic nylon (HYDROFIL®). Suitable hydrophilic fibers can also be obtained by hydrophilizing hydrophobic fibers, such as surfactant-treated or silica-treated thermoplastic fibers derived from, for example, polyolefins such as polyethylene or polypropylene, polyacrylics, polyamides, polystyrenes, polyurethanes and the like.

Another type of hydrophilic fiber for use in the present invention is chemically stiffened cellulosic fibers. As used herein, the term “chemically stiffened cellulosic fibers” means cellulosic fibers that have been stiffened by chemical means to increase the stiffness of the fibers under both dry and aqueous conditions. Such means can include the addition of a chemical stiffening agent that, for example, coats and/or impregnates the fibers. Such means can also include the stiffening of the fibers by altering the chemical structure, e.g., by crosslinking polymer chains.

Where fibers are used as the absorbent layer (or a constituent component thereof), the fibers can optionally be combined with a thermoplastic material. Upon melting, at least a portion of this thermoplastic material migrates to the intersections of the fibers, typically due to interfiber capillary gradients. These intersections become bond sites for the thermoplastic material. When cooled, the thermoplastic materials at these intersections solidify to form the bond sites that hold the matrix or web of fibers together in each of the respective layers. This can be beneficial in providing additional overall integrity to the cleaning consumable pad and/or compliant pad.

Amongst its various effects, bonding at the fiber intersections increases the overall compressive modulus and strength of the resulting thermally bonded member. In the case of the chemically stiffened cellulosic fibers, the melting and migration of the thermoplastic material also has the effect of increasing the average pore size of the resultant web, while maintaining the density and basis weight of the web as originally formed. This can improve the fluid acquisition properties of the thermally bonded web upon initial exposure to fluid, due to improved fluid permeability, and upon subsequent exposure, due to the combined ability of the stiffened fibers to retain their stiffness upon wetting and the ability of the thermoplastic material to remain bonded at the fiber intersections upon wetting and upon wet compression. In net, thermally bonded webs of stiffened fibers retain their original overall volume, but with the volumetric regions previously occupied by the thermoplastic material becoming open to thus increase the average interfiber capillary pore size.

Thermoplastic materials useful in the present invention can be in any of a variety of forms including particulates, fibers, or combinations of particulates and fibers. Thermoplastic fibers are a particularly preferred form because of their ability to form numerous interfiber bond sites. Suitable thermoplastic materials can be made from any thermoplastic polymer that can be melted at temperatures that will not extensively damage the fibers that comprise the primary web or matrix of each layer. The melting point of this thermoplastic material should be no lower than the temperature at which the thermally bonded absorbent structures, when used in the consumable pad and/or compliant pad, is likely to be stored.

The surface of the hydrophobic thermoplastic fiber can be rendered hydrophilic by treatment with a surfactant, such as a nonionic or anionic surfactant, e.g., by spraying the fiber with a surfactant, by dipping the fiber into a surfactant or by including the surfactant as part of the polymer melt in producing the thermoplastic fiber. Upon melting and resolidification, the surfactant will tend to remain at the surfaces of the thermoplastic fiber. Suitable thermoplastic fibers can be made from a single polymer (monocomponent fibers), or can be made from more than one polymer (e.g., bicomponent or multicomponent fibers). The “bicomponent fibers” may be thermoplastic fibers that comprise a core fiber made from one polymer that is encased within a thermoplastic sheath made from a different polymer. The polymer comprising the sheath often melts at a different, typically lower, temperature than the polymer comprising the core. As a result, these bicomponent fibers provide thermal bonding due to melting of the sheath polymer, while retaining the desirable strength characteristics of the core polymer.

Suitable bicomponent fibers for use in the present invention can include sheath/core fibers having the following polymer combinations: polyethylene/polypropylene, polyethylvinyl acetate/polypropylene, polyethylene/polyester, polypropylene/polyester, copolyester/polyester, and the like. Particularly suitable bicomponent thermoplastic fibers for use herein are those having a polypropylene or polyester core, and a lower melting copolyester, polyethylvinyl acetate or polyethylene sheath. These bicomponent fibers can be concentric or eccentric. As used herein, the terms “concentric” and “eccentric” refer to whether the sheath has a thickness that is even, or uneven, through the cross-sectional area of the bicomponent fiber. Eccentric bicomponent fibers can be desirable in providing more compressive strength at lower fiber thicknesses.

Various forming methods can be used to form a suitable fibrous web. For instance, the web can be made by nonwoven dry forming techniques, such as air-laying, or alternatively by wet laying, such as on a paper making machine. Other non-woven manufacturing techniques, including but not limited to techniques such as melt blown, spun bonded, needle punched, and hydroentanglement methods can also be used. In one embodiment, the dry fibrous web can be an air laid nonwoven web comprising a combination of natural fibers, staple length synthetic fibers and a latex binder.

In one embodiment, the cleaning consumable pad and/or compliant pad comprises at least two regions where the regions are distinguished by basis weight. Briefly, the measurement is achieved photographically, by differentiating dark (low basis weight) and light (high basis) network regions. In one aspect, the first region is relatively high basis weight and comprises an essentially continuous network. The second region comprises a plurality of mutually discrete regions of relatively low basis weight and which are circumscribed by the high basis weight first region.

In one embodiment, the cleaning consumable pad and/or compliant pad will have, in addition to regions which differ with regard to basis weight, substantial macroscopic three-dimensionality. The term “macroscopic three-dimensionality”, when used to describe three dimensional cleaning consumable pad and/or compliant pads means a three-dimensional pattern is readily visible to the naked.

In another embodiment, the consumable pad and/or compliant pad can comprise a laminate of two outer hydroentangled webs, such as nonwoven webs of polyester, rayon fibers or blends thereof having a basis weight of about 10 to about 60 grams per square meter, joined to an inner constraining layer, which can be in the form of net like scrim material which contracts upon heating to provide surface texture in the outer layers.

In addition to having consumable pad and/or compliant pads prepared using a mono-layer consumable pad and/or compliant pad, it is advantageous in some situations to have the consumable pad and/or compliant pad constructed having multiple layers. In one embodiment, the consumable pad and/or compliant pad consists of a multi-laminate structure comprising a pre-moistened outer layer, an impermeable film or membrane inner layer and second outer-layer which is substantially dry. To improve the wet capacity of the consumable pad and/or compliant pad and to protect the back layer from getting prematurely wet, an optional absorbent reservoir can be placed between the pre-moistened first outer-layer and the impermeable film or membrane. The dimensions of the reservoir can be smaller than the dimensions of the two outer layers to prevent liquid wicking from the front layer onto the back layer.

When a multi-laminate structure is used, the outer layer can contain hydrophobic fibers. The impermeable inner layer can be polyethylene, polypropylene or mixtures thereof. The composition mixture and thickness of the impermeable layer can be chosen so as to minimize any seepage of liquid from the pre-moistened first outer-layer to the dry second outer-layer. Those skilled in the art will appreciate that use of a reservoir core or of a high fluid capacity outer-layer may negatively impact the impermeable layer, such that more than one impermeable layer can be required to ensure sufficient dryness for the second outer-layer of the consumable pad and/or compliant pad. The reservoir, if present, can consist of treated or untreated cellulose, either as a stand alone material or as a hybrid with hydrophobic fibers. The second outer-layer, which is substantially dry-to-the-touch, can consist of high absorbency cellulose or blends of cellulose and synthetic fibers.

The consumable pad and/or compliant pad may also contain superabsorbent materials. A wide variety of high absorbency materials (also known as superabsorbent materials) are known to those skilled in the art. The superabsorbent materials can be natural, synthetic, and modified natural polymers and materials. In addition, the superabsorbent materials can be inorganic materials, such as silica gel, or organic compounds such as cross-linked polymers. The term “cross-linked” refers to any means for effectively rendering normally water-soluble materials substantially water insoluble but swellable. Such means can include, for example, physical entanglement, crystalline domains, covalent bonds, ionic complexes and associations, hydrophilic associations, such as hydrogen bonding, and hydrophobic associations of Van der Waals forces.

Examples of synthetic superabsorbent material polymers include the alkali metal and ammonium salts of poly(acrylic acid) and poly(methacrylic acid), poly(acrylamides), poly(vinyl ethers), maleic anhydride copolymers with vinyl ethers and alpha-olefins, poly(vinyl pyrrolidone), poly(vinylmorpholinone), poly(vinyl alcohol), and mixtures and copolymers thereof. Further superabsorbent materials include natural and modified natural polymers, such as hydrolyzed acrylonitrile-grafted starch, acrylic acid grafted starch, methyl cellulose, chitosan, carboxymethyl cellulose, hydroxypropyl cellulose, and the natural gums, such as alginates, xanthan gum, locust bean gum and the like. Mixtures of natural and wholly or partially synthetic superabsorbent polymers can also be useful in the present invention.

Cleaning Composition for Pads: In one embodiment, the cleaning device comprises a cleaning consumable pad and/or compliant pad that is impregnated with a cleaning composition and is ‘wet-to-the-touch’. In another embodiment, the cleaning device comprises a cleaning consumable pad and/or compliant pad that are impregnated with a cleaning composition that is ‘dry-to-the-touch’. By ‘dry-to-the-touch’, it is meant that the consumable pad and/or compliant pad has no visible liquid on the outside of the consumable pad and/or compliant pad and does not drip under gravity, but without externally applied pressure. A ‘dry-to-the-touch’ consumable pad and/or compliant pad may expel liquid when squeezed. In another embodiment, the cleaning device contains a removable attached vessel containing a cleaning composition and the cleaning consumable pad and/or compliant pad is free of the cleaning composition.

The cleaning composition may contain one or more surfactants selected from anionic, nonionic, cationic, ampholytic, amphoteric and zwitterionic surfactants and mixtures thereof. Where present, ampholytic, amphotenic and zwitterionic surfactants are generally used in combination with one or more anionic and/or nonionic surfactants.

The cleaning composition may comprise an anionic surfactant. Essentially any anionic surfactants useful for detersive purposes can be comprised in the cleaning composition. These can include salts (including, for example, sodium, potassium, ammonium, and substituted ammonium salts such as mono-, di- and tri-ethanolamine salts) of the anionic sulfate, sulfonate, carboxylate and sarcosinate surfactants. Anionic surfactants may comprise a sulfonate or a sulfate surfactant. Anionic surfactants may comprise an alkyl sulfate, a linear or branched alkyl benzene sulfonate, or an alkyldiphenyloxide disulfonate, as described herein.

Other anionic surfactants include the isethionates such as the acyl isethionates, N-acyl taurates, fatty acid amides of methyl tauride, alkyl succinates and sulfosuccinates, monoesters of sulfosuccinate (for instance, saturated and unsaturated C12-C18 monoesters) diesters of sulfosuccinate (for instance saturated and unsaturated C6-C14 diesters), N-acyl sarcosinates. Resin acids and hydrogenated resin acids are also suitable, such as rosin, hydrogenated rosin, and resin acids and hydrogenated resin acids present in or derived from tallow oil. Anionic sulfate surfactants suitable for use herein include the linear and branched primary and secondary alkyl sulfates, alkyl ethoxysulfates, fatty oleoyl glycerol sulfates, alkyl phenol ethylene oxide ether sulfates, the C5-C17 acyl-N—(C1-C4 alkyl) and —N—(C1-C2 hydroxyalkyl)glucamine sulfates, and sulfates of alkylpolysacchanides such as the sulfates of alkylpolyglucoside (the nonionic nonsulfated compounds being described herein). Alkyl sulfate surfactants may be selected from the linear and branched primary C10-C18 alkyl sulfates, the C11-C15 branched chain alkyl sulfates, or the C12-C14 linear chain alkyl sulfates.

Alkyl ethoxysulfate surfactants may be selected from the group consisting of the C10-C18 alkyl sulfates which have been ethoxylated with from 0.5 to 20 moles of ethylene oxide per molecule. The alkyl ethoxysulfate surfactant may be a C11-C18, or a C11-C15 alkyl sulfate which has been ethoxylated with from 0.5 to 7, or from 1 to 5, moles of ethylene oxide per molecule. One aspect of the invention employs mixtures of the alkyl sulfate and/or sulfonate and alkyl ethoxysulfate surfactants. Such mixtures have been disclosed in PCT Patent Application No. WO 93/18124.

Anionic sulfonate surfactants suitable for use herein include the salts of C5-C20 linear alkylbenzene sulfonates, alkyl ester sulfonates, C6-C22 primary or secondary alkane sulfonates, C6-C24 olefin sulfonates, sulfonated polycarboxylic acids, alkyl glycerol sulfonates, fatty acyl glycerol sulfonates, fatty oleyl glycerol sulfonates, and any mixtures thereof. Suitable anionic carboxylate surfactants include the alkyl ethoxy carboxylates, the alkyl polyethoxy polycarboxylate surfactants and the soaps (‘alkyl carboxyls’), especially certain secondary soaps as described herein. Suitable alkyl ethoxy carboxylates include those with the formula RO(CH2CH20)xCH2COO—M+ wherein R is a C6 to C18 alkyl group, x ranges from 0 to 10, and the ethoxylate distribution is such that, on a weight basis, the amount of material where x is 0 is less than 20% and M is a cation. Suitable alkyl polyethoxypolycarboxylate surfactants include those having the formula RO—(CHR1—CHR2—O)—R3 wherein R is a C6 to C18 alkyl group, x is from 1 to 25, R1 and R2 are selected from the group consisting of hydrogen, methyl acid radical, succinic acid radical, hydroxysuccinic acid radical, and mixtures thereof, and R3 is selected from the group consisting of hydrogen, substituted or unsubstituted hydrocarbon having between 1 and 8 carbon atoms, and mixtures thereof.

Suitable soap surfactants include the secondary soap surfactants, which contain a carboxyl unit connected to a secondary carbon. Suitable secondary soap surfactants for use herein are water-soluble members selected from the group consisting of the water-soluble salts of 2-methyl-1-undecanoic acid, 2-ethyl-1-decanoic acid, 2-propyl-1-nonanoic acid, 2-butyl-1-octanoic acid and 2-pentyl-1-heptanoic acid. Certain soaps may also be included as suds suppressors.

Other suitable anionic surfactants are the alkali metal sarcosinates of formula R—CON(R1)CH—)COOM, wherein R is a C5-C17 linear or branched alkyl or alkenyl group, R1 is a C1-C4 alkyl group and M is an alkali metal ion. Examples are the myristyl and oleoyl methyl sarcosinates in the form of their sodium salts.

Essentially any alkoxylated nonionic surfactants are suitable herein, for instance, ethoxylated and propoxylated nonionic surfactants. Alkoxylated surfactants can be selected from the classes of the nonionic condensates of alkyl phenols, nonionic ethoxylated alcohols, nonionic ethoxylated/propoxylated fatty alcohols, nonionic ethoxylate/propoxylate condensates with propylene glycol, and the nonionic ethoxylate condensation products with propylene oxide/ethylene diamine adducts.

Polyhydroxy fatty acid amides suitable for use herein are those having the structural formula R2CONR1Z wherein: R1 is H, C1-C4 hydrocarbyl, 2-hydroxyethyl, 2-hydroxypropyl, ethoxy, propoxy, or a mixture thereof, for instance, C1-C4 alkyl, or C1 or C2 alkyl; and R2 is a C5-C31 hydrocarbyl, for instance, straight-chain C5-C19 alkyl or alkenyl, or straight-chain C9-C17 alkyl or alkenyl, or straight-chain C11-C17 alkyl or alkenyl, or mixture thereof-, and Z is a polyhydroxyhydrocarbyl having a linear hydrocarbyl chain with at least 3 hydroxyls directly connected to the chain, or an alkoxylated derivative (for example, ethoxylated or propoxylated) thereof. Z may be derived from a reducing sugar in a reductive amination reaction, for example, Z is a glycityl.

Suitable fatty acid amide surfactants include those having the formula: R1CON(R2)2 wherein R1 is an alkyl group containing from 7 to 21, or from 9 to 17 carbon atoms and each R2 is selected from the group consisting of hydrogen, C1-C4 alkyl, C1-C4 hydroxyalkyl, and —(C2H4O)xH, where x is in the range of from 1 to 3.

Suitable alkylpolysaccharides for use herein are disclosed in U.S. Pat. No. 4,565,647 to Llenado, having a hydrophobic group containing from 6 to 30 carbon atoms and a polysaccharide, e.g., a polyglycoside, hydrophilic group containing from 1.3 to 10 saccharide units. Alkylpolyglycosides may have the formula: R2O(CnH2nO)t(glycosyl)x wherein R2 is selected from the group consisting of alkyl, alkylphenyl, hydroxyalkyl, hydroxyalkylphenyl, and mixtures thereof in which the alkyl groups contain from 10 to 18 carbon atoms; n is 2 or 3; t is from 0 to 10, and x is from 1.3 to 8. The glycosyl may be derived from glucose.

Suitable amphoteric surfactants for use herein include the amine oxide surfactants and the alkyl amphocarboxylic acids. Suitable amine oxides include those compounds having the formula R3(OR4)xNO(R5)2 wherein R3 is selected from an alkyl, hydroxyalkyl, acylamidopropyl and alkylphenyl group, or mixtures thereof, containing from 8 to 26 carbon atoms; R4 is an alkylene or hydroxyalkylene group containing from 2 to 3 carbon atoms, or mixtures thereof, x is from 0 to 5, preferably from 0 to 3; and each R5 is an alkyl or hydroxyalkyl group containing from 1 to 3, or a polyethylene oxide group containing from 1 to 3 ethylene oxide groups. Suitable amine oxides are C10-C18 alkyl dimethylamine oxide, and C10-18 acylamido alkyl dimethylamine oxide.

Zwitterionic surfactants can also be incorporated into the cleaning compositions. These surfactants can be broadly described as derivatives of secondary and tertiary amines, derivatives of heterocyclic secondary and tertiary amines, or derivatives of quaternary ammonium, quaternary phosphonium or tertiary sulfonium compounds. Betaine and sultaine surfactants are exemplary zwittenionic surfactants for use herein.

Suitable betaines are those compounds having the formula R(R1)2N+R2COO— wherein R is a C6-C18 hydrocarbyl. group, each R1 is typically C1-C3 alkyl, and R2 is a C1-05 hydrocarbyl group. Suitable betaines are C12-18 dimethyl-ammonio hexanoate and the C10-18 acylamidopropane (or ethane) dimethyl (or diethyl) betaines. Complex betaine surfactants are also suitable for use herein.

Suitable cationic surfactants to be used herein include the quaternary ammonium surfactants. The quaternary ammonium surfactant may be a mono C6-C16, or a C6-C10 N-alkyl or alkenyl ammonium surfactant wherein the remaining N positions are substituted by methyl, hydroxyethyl or hydroxypropyl groups. Suitable are also the mono-alkoxylated and bis-alkoxylated amine surfactants.

Another suitable group of cationic surfactants, which can be used in the cleaning compositions, are cationic ester surfactants. The cationic ester surfactant is a compound having surfactant properties comprising at least one ester (i.e. —COO—) linkage and at least one cationically charged group. The ester linkage and cationically charged group may be separated from each other in the surfactant molecule by a spacer group consisting of a chain comprising at least three atoms (i.e. of three atoms chain length), or from three to eight atoms, or from three to five atoms, or three atoms. The atoms forming the spacer group chain are selected from the group consisting, of carbon, nitrogen and oxygen atoms and any mixtures thereof, with the proviso that any nitrogen or oxygen atom in said chain connects only with carbon atoms in the chain. Thus spacer groups having, for example, —O—O— (i.e. peroxide), —N—N—, and —N—O— linkages are excluded, whilst spacer groups having, for example —CH2—O—, CH2— and —CH2—NH—CH2— linkages are included. The spacer group chain may comprise only carbon atoms, or the chain is a hydrocarbyl chain.

The cleaning composition may comprise cationic mono-alkoxylated amine surfactants, for instance, of the general formula: R1R2R3N+ApR4X— wherein R1 is an alkyl or alkenyl moiety containing from about 6 to about 18 carbon atoms, or from 6 to about 16 carbon atoms, or from about 6 to about 14 carbon atoms; R2 and R3 are each independently alkyl groups containing from one to about three carbon atoms, for instance, methyl, for instance, both R2 and R3 are methyl groups; R4 is selected from hydrogen, methyl and ethyl; X— is an anion such as chloride, bromide, methylsulfate, sulfate, or the like, to provide electrical neutrality; A is an alkoxy group, especially a ethoxy, propoxy or butoxy group; and p is from 0 to about 30, or from 2 to about 15, or from 2 to about 8. The ApR4 group in the formula may have p=1 and is a hydroxyalkyl group, having no greater than 6 carbon atoms whereby the —OH group is separated from the quaternary ammonium nitrogen atom by no more than 3 carbon atoms. Suitable ApR4 groups are —CH2CH2—OH, —CH2CH2CH2—OH, —CH2CH(CH3)—OH and —CH(CH3)CH2—OH. Suitable R1 groups are linear alkyl groups, for instance, linear R1 groups having from 8 to 14 carbon atoms.

Suitable cationic mono-alkoxylated amine surfactants for use herein are of the formula R1(CH3)(CH3)N+(CH2CH2O)2-5HX— wherein R1 is C10-C18 hydrocarbyl and mixtures thereof, especially C10-C14 alkyl, or C10 and C12 alkyl, and X is any convenient anion to provide charge balance, for instance, chloride or bromide.

As noted, compounds of the foregoing type include those wherein the ethoxy (CH2CH2O) units (EO) are replaced by butoxy, isopropoxy [CH(CH3)CH2O] and [CH2CH(CH3)O] units (i-Pr) or n-propoxy units (Pr), or mixtures of EO and/or Pr and/or i-Pr units.

The cationic bis-alkoxylated amine surfactant may have the general formula: R1R2N+ApR3A′qR4X— wherein R1 is an alkyl or alkenyl moiety containing from about 8 to about 18 carbon atoms, or from 10 to about 16 carbon atoms, or from about 10 to about 14 carbon atoms; R2 is an alkyl group containing from one to three carbon atoms, for instance, methyl; R3 and R4 can vary independently and are selected from hydrogen, methyl and ethyl, X— is an anion such as chloride, bromide, methylsulfate, sulfate, or the like, sufficient to provide electrical neutrality. A and A′ can vary independently and are each selected from C1-C4 alkoxy, for instance, ethoxy, (i.e., —CH2CH2O—), propoxy, butoxy and mixtures thereof, p is from 1 to about 30, or from 1 to about 4 and q is from 1 to about 30, or from 1 to about 4, or both p and q are 1.

Suitable cationic bis-alkoxylated amine surfactants for use herein are of the formula R1CH3N+(CH2CH2OH)(CH2CH2OH)X—, wherein R1 is C10-C18 hydrocarbyl and mixtures thereof, or C10, C12, C14 alkyl and mixtures thereof, X— is any convenient anion to provide charge balance, for example, chloride. With reference to the general cationic bis-alkoxylated amine structure noted above, since in one example compound R1 is derived from (coconut) C12-C14 alkyl fraction fatty acids, R2 is methyl and ApR3 and A′qR4 are each monoethoxy.

Other cationic bis-alkoxylated amine surfactants useful herein include compounds of the formula: R1R2N+—(CH2CH2O)pH—(CH2CH2O)qH X— wherein R1 is C10-C18 hydrocarbyl, or C10-C14 alkyl, independently p is 1 to about 3 and q is 1 to about 3, R2 is C1-C3 alkyl, for example, methyl, and X— is an anion, for example, chloride or bromide.

Other compounds of the foregoing type include those wherein the ethoxy (CH2CH2O) units (EO) are replaced by butoxy (Bu) isopropoxy [CH(CH3)CH2O] and [CH2CH(CH3)O] units (i-Pr) or n-propoxy units (Pr), or mixtures of EO and/or Pr and/or i-Pr units.

Solvents for Pads: Suitable organic solvents include, but are not limited to, C1-6 alkanols, C1-6 diols, C1-10 alkyl ethers of alkylene glycols, C3-24 alkylene glycol ethers, polyalkylene glycols, short chain carboxylic acids, short chain esters, isoparafinic hydrocarbons, mineral spirits, alkylaromatics, terpenes, terpene derivatives, terpenoids, terpenoid derivatives, formaldehyde, and pyrrolidones. Alkanols include, but are not limited to, methanol, ethanol, n-propanol, isopropanol, butanol, pentanol, and hexanol, and isomers thereof. Diols include, but are not limited to, methylene, ethylene, propylene and butylene glycols. Alkylene glycol ethers include, but are not limited to, ethylene glycol monopropyl ether, ethylene glycol monobutyl ether, ethylene glycol monohexyl ether, diethylene glycol monopropyl ether, diethylene glycol monobutyl ether, diethylene glycol monohexyl ether, propylene glycol methyl ether, propylene glycol ethyl ether, propylene glycol n-propyl ether, propylene glycol monobutyl ether, propylene glycol t-butyl ether, di- or tri-polypropylene glycol methyl or ethyl or propyl or butyl ether, acetate and propionate esters of glycol ethers. Short chain carboxylic acids include, but are not limited to, acetic acid, glycolic acid, lactic acid and propionic acid. Short chain esters include, but are not limited to, glycol acetate, and cyclic or linear volatile methylsiloxanes. Water insoluble solvents such as isoparafinic hydrocarbons, mineral spirits, alkylaromatics, terpenoids, terpenoid derivatives, terpenes, and terpenes derivatives can be mixed with a water soluble solvent when employed.

Examples of organic solvents having low vapor pressure at room temperature include, but are not limited to, dipropylene glycol n-propyl ether, dipropylene glycol t-butyl ether, dipropylene glycol n-butyl ether, tripropylene glycol methyl ether, tripropylene glycol n-butyl ether, diethylene glycol propyl ether, diethylene glycol butyl ether, dipropylene glycol methyl ether acetate, diethylene glycol ethyl ether acetate, and diethylene glycol butyl ether acetate.

Additional Adjuncts: The cleaning compositions optionally contain one or more of the following adjuncts: stain and soil repellants, lubricants, odor control agents, perfumes, fragrances and fragrance release agents, brighteners, fluorescent whitening agents, and bleaching agents. Other adjuncts include, but are not limited to, acids, electrolytes, dyes and/or colorants, solubilizing materials, stabilizers, thickeners, defoamers, hydrotropes, cloud point modifiers, preservatives, and other polymers. The solubilizing materials, when used, include, but are not limited to; hydrotropes (e.g. water soluble salts of low molecular weight organic acids such as the sodium and/or potassium salts of toluene, cumene, and xylene sulfonic acid). The acids, when used, include, but are not limited to, organic hydroxy acids, citric acids, keto acid, and the like. Electrolytes, when used, include, calcium, sodium and potassium chloride. Thickeners, when used, include, but are not limited to, polyacrylic acid, xanthan gum, calcium carbonate, aluminum oxide, alginates, guar gum, methyl, ethyl, clays, and/or propyl hydroxycelluloses. Defoamers, when used, include, but are not limited to, silicones, aminosilicones, silicone blends, and/or silicone/hydrocarbon blends. Bleaching agents, when used, include, but are not limited to, peracids, hypohalite sources, hydrogen peroxide, and/or sources of hydrogen peroxide.

Preservatives, when used, include, but are not limited to, mildewstat or bacteriostat, methyl, ethyl and propyl parabens, short chain organic acids (e.g. acetic, lactic and/or glycolic acids), bisguanidine compounds and/or short chain alcohols. The mildewstat or bacteriostat includes, but is not limited to, mildewstats (including non-isothiazolone compounds) include chloro-2-methyl-4-isothiazolin-3-one, 2-methyl-4-isothiazolin-3-one, and a blend thereof, and 5-chloro-2-methyl-4-isothiazolin-3-one, 2-bromo-2-nitropropane 1,3 diol, propyl-p-hydroxybenzoate, o-phenyl-phenol Na+ salt, 1,2-benzoisothiazolin-3-one and 2,4,4′-trichloro-2-hydroxydiphenylether.

Antimicrobial Agent: Antimicrobial agents include quaternary ammonium compounds and phenolics. Non-limiting examples of these quaternary compounds include benzalkonium chlorides and/or substituted benzalkonium chlorides, di(C6-C14)alkyl di short chain (C1-4 alkyl and/or hydroxyalkl) quaternaryammonium salts, N-(3-chloroallyl) hexaminium chlorides, benzethonium chloride, methylbenzethonium chloride, and cetylpyridinium chloride. Other quaternary compounds include the group consisting of dialkyldimethyl ammonium chlorides, alkyl dimethylbenzylammonium chlorides, dialkylmethylbenzylammonium chlorides, and mixtures thereof. Biguanide antimicrobial actives including, but not limited to polyhexamethylene biguanide hydrochloride, p-chlorophenyl biguanide; 4-chlorobenzhydryl biguanide, halogenated hexidine such as, but not limited to, chlorhexidine (1,1′-hexamethylene-bis-5-(4-chlorophenyl biguanide) and its salts are also in this class.

Surfactant Buffer for Pads: The cleaning composition may include a buffer, which increases the effectiveness of the surfactant. The buffer can also function as a softener and/or a sequestering agent in the cleaning composition. A variety of buffers can be used and they include, but are not limited to, phosphate-silicate compounds, zeolites, alkali metal, ammonium and substituted ammonium polyacetates, trialkali salts of nitrilotriacetic acid, carboxylates, polycarboxylates, carbonates, bicarbonates, polyphosphates, aminopolycarboxylates, polyhydroxysulfonates, and starch derivatives.

Buffers can also include polyacetates and polycarboxylates. The polyacetate and polycarboxylate compounds include, but are not limited to, sodium, potassium, lithium, ammonium, and substituted ammonium salts of ethylenediamine tetraacetic acid, ethylenediamine triacetic acid, ethylenediamine tetrapropionic acid, diethylenetriamine pentaacetic acid, nitrilotriacetic acid, oxydisuccinic acid, iminodisuccinic acid, mellitic acid, polyacrylic acid or polymethacrylic acid and copolymers, benzene polycarboxylic acids, gluconic acid, sulfamic acid, oxalic acid, phosphoric acid, phosphonic acid, organic phosphonic acids, acetic acid, and citric acid. These buffers can also exist either partially or totally in the hydrogen ion form.

The builder agent can include sodium and/or potassium salts of EDTA and substituted ammonium salts. The substituted ammonium salts include, but are not limited to, ammonium salts of methylamine, dimethylamine, butylamine, butylenediamine, propylamine, triethylamine, trimethylamine, monoethanolamine, diethanolamine, triethanolamine, isopropanolamine, ethylenediamine tetraacetic acid and propanolamine.

Buffering and pH adjusting agents, when used, include, but are not limited to, organic acids, mineral acids, alkali metal and alkaline earth salts of silicate, metasilicate, polysilicate, borate, hydroxide, carbonate, carbamate, phosphate, polyphosphate, pyrophosphates, triphosphates, tetraphosphates, ammonia, hydroxide, monoethanolamine, monopropanolamine, diethanolamine, dipropanolamine, triethanolamine, and 2-amino-2methylpropanol. Preferred buffering agents for compositions of this invention are nitrogen-containing materials. Some examples are amino acids such as lysine or lower alcohol amines like mono-, di-, and tri-ethanolamine. Other preferred nitrogen-containing buffering agents are tri(hydroxymethyl)amino methane (TRIS), 2-amino-2-ethyl-1,3-propanediol, 2-amino-2-methly-propanol, 2-amino-2-methyl-1,3-propanol, disodium glutamate, N-methyl diethanolamide, 2-dimethylamino-2-methylpropanol (DMAMP), 1,3-bis(methylamine)-cyclohexane, 1,3-diamino-propanol N,N′-tetra-methyl-1,3-diamino-2-propanol, N,N-bis(2-hydroxyethyl)glycine (bicine) and N-tris(hydroxymethyl)methyl glycine (tricine). Other suitable buffers include ammonium carbamate, citric acid, acetic acid. Mixtures of any of the above are also acceptable. Useful inorganic buffers/alkalinity sources include ammonia, the alkali metal carbonates and alkali metal phosphates, e.g., sodium carbonate, sodium polyphosphate. Other preferred pH adjusting agents include sodium or potassium hydroxide.

Effervescence in Pads: The cleaning composition may comprise materials which effervesce when combined with water. The materials may be within a water-soluble, water-insoluble, or water-dispersible pocket to slow the effervescent action or to protect the composition from premature hydration. The materials may comprise a polymeric agent to slow the effervescence. One component of the effervescent materials may be an acidic material. Suitable for this purpose are any acids present in dry solid form. Suitable for this purpose are C2-20 organic mono- and poly-carboxylic acids such as alpha- and beta-hydroxycarboxylic acids; C2-20 organophosphorus acids such as phytic acid; C2-20 organosulfur acids such as toluene sulfonic acid; and peroxides such as hydrogen peroxide or materials that generate hydrogen peroxide in solution. Typical hydroxycarboxylic acids include adipic, glutaric, succinic, tartaric, malic, maleic, lactic, salicylic and citric acids as well as acid forming lactones such as gluconolactone and gluccrolactone. A suitable acid is citric acid. Also suitable as acid material may be encapsulated acids. Typical encapsulating material may include water-soluble synthetic or natural polymers such as polyacrylates (e.g. encapsulating polyacrylic acid), cellulosic gums, polyurethane and polyoxyalkylene polymers.

Another component of the effervescent materials may be a alkaline material. The alkaline material may a substance which can generate a gas such as carbon dioxide, nitrogen or oxygen, i.e. effervesce, when contacted with water and the acidic material. Suitable alkaline materials are anhydrous salts of carbonates and bicarbonates, alkaline peroxides (e.g. sodium perborate and sodium percarbonate) and azides (e.g. sodium azide).

Essential Oils in Pads: Compositions according to the invention may comprise essential oils, as well as pine oil and terpene derivatives for cleaning efficacy. They may also provide some antimicrobial efficacy and deodorizing properties.

Terpene derivatives appropriate for use in the inventive composition include terpene hydrocarbons having a functional group, such as terpene alcohols, terpene ethers, terpene esters, terpene aldehydes and terpene ketones. Examples of suitable terpene alcohols include verbenol, transpinocarveol, cis-2-pinanol, nopol, isoborneol, carbeol, piperitol, thymol, alpha-terpineol, terpinen-4-ol, menthol, 1,8-terpin, dihydro-terpineol, nerol, geraniol, linalool, citronellol, hydroxycitronellol, 3,7-dimethyl octanol, dihydro-myrcenol, tetrahydro-alloocimenol, perillalcohol, and falcarindiol. Examples of suitable terpene ether and terpene ester solvents include 1,8-cineole, 1,4-cineole, isobornyl methylether, rose pyran, menthofuran, trans-anethole, methyl chavicol, allocimene diepoxide, limonene mono-epoxide, isobornyl acetate, nonyl acetate, terpinyl acetate, linalyl acetate, geranyl acetate, citronellyl acetate, dihydro-terpinyl acetate and meryl acetate. Further, examples of suitable terpene aldehyde and terpene ketone solvents include myrtenal, campholenic aldehyde, perillaldehyde, citronellal, citral, hydroxy citronellal, camphor, verbenone, carvenone, dihydro-carvone, carvone, piperitone, menthone, geranyl acetone, pseudo-ionone, ionine, iso-pseudo-methyl ionone, n-pseudo-methyl ionone, iso-methyl ionone and n-methyl ionone.

Essential oils include, but are not limited to, those obtained from thyme, lemongrass, citrus, lemons, oranges, anise, clove, aniseed, pine, cinnamon, geranium, roses, mint, lavender, citronella, eucalyptus, peppermint, camphor, sandalwood, rosmarin, vervain, fleagrass, lemongrass, ratanhiae, cedar and mixtures thereof. Preferred essential oils to be used herein are thyme oil, clove oil, cinnamon oil, geranium oil, eucalyptus oil, peppermint oil, mint oil or mixtures thereof.

Actives of essential oils to be used herein include, but are not limited to, thymol (present for example in thyme), eugenol (present for example in cinnamon and clove), menthol (present for example in mint), geraniol (present for example in geranium and rose), verbenone (present for example in vervain), eucalyptol and pinocarvone (present in eucalyptus), cedrol (present for example in cedar), anethol (present for example in anise), carvacrol, hinokitiol, berberine, ferulic acid, cinnamic acid, methyl salycilic acid, methyl salycilate, terpineol and mixtures thereof. Preferred actives of essential oils to be used herein are thymol, eugenol, verbenone, eucalyptol, terpineol, cinnamic acid, methyl salycilic acid, citric acid and/or geraniol.

Other essential oils include Anethole 20/21 natural, Aniseed oil china star, Aniseed oil globe brand, Balsam (Peru), Basil oil (India), Black pepper oil, Black pepper oleoresin 40/20, Bois de Rose (Brazil) FOB, Bomeol Flakes (China), Camphor oil, White, Camphor powder synthetic technical, Canaga oil (Java), Cardamom oil, Cassia oil (China), Cedarwood oil (China) BP, Cinnamon bark oil, Cinnamon leaf oil, Citronella oil, Clove bud oil, Clove leaf, Coriander (Russia), Coumarin 69° C. (China), Cyclamen Aldehyde, Diphenyl oxide, Ethyl vanilin, Eucalyptol, Eucalyptus oil, Eucalyptus citriodora, Fennel oil, Geranium oil, Ginger oil, Ginger oleoresin (India), White grapefruit oil, Guaiacwood oil, Gurjun balsam, Heliotropin, Isobornyl acetate, Isolongifolene, Juniper berry oil, L-methhyl acetate, Lavender oil, Lemon oil, Lemongrass oil, Lime oil distilled, Litsea Cubeba oil, Longifolene, Menthol crystals, Methyl cedryl ketone, Methyl chavicol, Methyl salicylate, Musk ambrette, Musk ketone, Musk xylol, Nutmeg oil, Orange oil, Patchouli oil, Peppermint oil, Phenyl ethyl alcohol, Pimento berry oil, Pimento leaf oil, Rosalin, Sandalwood oil, Sandenol, Sage oil, Clary sage, Sassafras oil, Spearmint oil, Spike lavender, Tagetes, Tea tree oil, Vanilin, Vetyver oil (Java), Wintergreen.

Consumer preferences for oils include peppermint oil, lavender oil, bergamot oil (Italian), rosemary oil (Tunisian), and sweet orange oil. Particularly useful lemon oil and d-limonene compositions which are useful in the invention include mixtures of terpene hydrocarbons obtained from the essence of oranges, e.g., cold-pressed orange terpenes and orange terpene oil phase ex fruit juice, and the mixture of terpene hydrocarbons expressed from lemons and grapefruit.

Polymers for Pads: In suitable embodiments of the invention, polymeric material that changes the viscosity characteristics of the compositions is incorporated. For some combinations of cleaning compositions and consumable pad and/or compliant pads a thickener may be suitable. Thickeners, when used, include, but are not limited to, polyacrylic acid and copolymers, polysaccharide polymers, which include substituted cellulose materials like carboxymethylcellulose, ethyl cellulose, hydroxyethylcellulose, hydroxyprop ylcellulo se, hydroxymethylcellulose, succinoglycan and naturally occurring polysaccharide polymers like xanthan gum, guar gum, locust bean gum, tragacanth gum or derivatives thereof.

In suitable embodiments of the invention, polymeric material that improves the hydrophilicity of the surface being treated is incorporated into the present compositions. The increase in hydrophilicity provides improved final appearance by providing “sheeting” of the water from the surface and/or spreading of the water on the surface, and this effect is preferably seen when the surface is rewetted and even when subsequently dried after the rewetting. Polymer substantivity is beneficial as it prolongs the sheeting and cleaning benefits.

In general, the aqueous polymer containing composition may comprise a water-soluble or water dispersible polymer. The hydrophilic polymers preferably are attracted to surfaces and are absorbed thereto without covalent bonds. Examples of suitable polymers include the polymers and co-polymers of N,N dimethyl acrylamide, acrylamide, and certain monomers containing quaternary ammonium groups or amphoteric groups that favor substantivity to surfaces, along with co-monomers that favor adsorption of water, such as, for example, acrylic acid and other acrylate salts, sulfonates, betaines, and ethylene oxides.

The average molecular weight of the copolymer typically ranges from about 5,000 to about 10,000,000, with the preferred molecular weight range depending on the polymer composition with the proviso that the molecular weight is selected so that the copolymer is water soluble or water dispersible.

Examples of permanently cationic monomers include, but are not limited to, quaternary ammonium salts of substituted acrylamide, methacrylamide, acrylate and methacrylate, such as trimethylammoniumethylmethacrylate, trimethylammoniumpropylmethacrylamide, trimethylammoniumethylmethacrylate, trimethylammoniumpropylacrylamide, 2-vinyl N-alkyl quaternary pyridinium, 4-vinyl N-alkyl quaternary pyridinium, 4-vinylbenzyltrialkylammonium, 2-vinyl piperidinium, 4-vinyl piperidinium, 3-alkyl 1-vinyl imidazolium, diallyldimethylammonium, and the ionene class of internal cationic monomers. This class includes co-poly ethylene imine, co-poly ethoxylated ethylene imine and co-poly quaternized ethoxylated ethylene imine, co-poly [(dimethylimino) trimethylene (dimethylimino) hexamethylene disalt], co-poly [(diethylimino) trimethylene (dimethylimino) trimethylene disalt], co-poly [(dimethylimino) 2-hydroxypropyl salt], co-polyquarternium-2, co-polyquarternium-17, and co-polyquarternium-18. Other cationic monomers include those containing cationic sulfonium salts such as co-poly-1-[3-methyl-4-(vinyl-benzyloxy)phenyl] tetrahydrothiophenium chloride. Especially preferred monomers are mono- and di-quaternary derivatives of methacrylamide. The counterion of the cationic co-monomer can be selected from, for example, chloride, bromide, iodide, hydroxide, phosphate, sulfate, hydrosulfate, ethyl sulfate, methyl sulfate, formate, and acetate.

Examples of monomers that are cationic on protonation include, but are not limited to, acrylamide, N,N-dimethylacrylamide, N,N di-isopropylacryalmide, N-vinylimidazole, N-vinylp yrrolidone, ethyleneimine, dimethylaminohydroxypropyl diethylenetriamine, dimethylaminoethylmethacrylate, dimethylaminopropylmethacrylamide, dimethylaminoethylacrylate, dimethylaminopropylacrylamide, 2-vinyl pyridine, 4-vinyl pyridine, 2-vinyl piperidine, 4-vinylpiperidine, vinyl amine, diallylamine, methyldiallylamine, vinyl oxazolidone; vinyl methyoxazolidone, and vinyl caprolactam.

Examples of acidic monomers that are capable of forming an anionic charge in the composition include, but are not limited to, acrylic acid, methacrylic acid, ethacrylic acid, dimethylacrylic acid, maleic anhydride, succinic anhydride, vinylsulfonate, cyanoacrylic acid, methylenemalonic acid, vinylacetic acid, allylacetic acid, ethylidineacetic acid, propylidineacetic acid, crotonic acid, fumaric acid, itaconic acid, sorbic acid, angelic acid, cinnamic acid, styrylacrylic acid, citraconic acid, glutaconic acid, aconitic acid, phenylacrylic acid, acryloxypropionic acid, citraconic acid, vinylbenzoic acid, N-vinylsuccinamidic acid, mesaconic acid, methacroylalanine, acryloylhydroxyglycine, sulfoethyl methacrylate, sulfopropyl acrylate, and sulfoethyl acrylate. Preferred acid monomers also include styrenesulfonic acid, 2-methacrylo yloxymethane-1-sulfonic acid, 3-methacrylo yloxypropane-1-sulfonic acid, 3-(vinyloxy)propane-1-sulfonic acid, ethylenesulfonic acid, vinyl sulfuric acid, 4-vinylphenyl sulfuric acid, ethylene phosphonic acid and vinyl phosphoric acid. Most preferred monomers include acrylic acid, methacrylic acid and maleic acid. The copolymers useful in this invention may contain the above acidic monomers and the alkali metal, alkaline earth metal, and ammonium salts thereof.

Examples of monomers having an uncharged hydrophilic group include but are not limited to vinyl alcohol, vinyl acetate, vinyl methyl ether, vinyl ethyl ether, ethylene oxide and propylene oxide. Especially preferred are hydrophilic esters of monomers, such as hydroxyalkyl acrylate esters, alcohol ethoxylate esters, alkylpolyglycoside esters, and polyethylene glycol esters of acrylic and methacrylic acid. Finally, examples of uncharged hydrophobic monomers include, but are not limited to, C1-C4 alkyl esters of acrylic acid and of methacrylic acid.

Other examples of polymers that provide the sheeting and anti-spotting benefits are polymers that contain amine oxide hydrophilic groups. Polymers that contain other hydrophilic groups such a sulfonate, pyrrolidone, and/or carboxylate groups can also be used. Examples of desirable poly-sulfonate polymers include polyvinylsulfonate and polystyrene sulfonate. A typical formula is as follows: [CH(C6H4SO3Na)—CH2]n—CH(C6H5)—CH2 wherein n is a number to give the appropriate molecular weight as disclosed below.

Typical molecular weights are from about 10,000 to about 1,000,000, preferably from about 200,000 to about 700,000. Preferred polymers containing pyrrolidone functionalities include polyvinyl pyrrolidone, quaternized pyrrolidone derivatives, and co-polymers containing pyrrolidone, such as polyvinylpyrrolidone/dimethylaminoethylmethacrylate and polyvinyl pyrrolidone/acrylate. Other materials can also provide substantivity and hydrophilicity including cationic materials that also contain hydrophilic groups and polymers that contain multiple ether linkages. Cationic materials include cationic sugar and/or starch derivatives and the typical block copolymer detergent surfactants based on mixtures of polypropylene oxide and ethylene oxide are representative of the polyether materials. The polyether materials are less substantive, however.

Some non-limiting examples of homopolymers and copolymers which can be used as water soluble polymers of the present invention are: adipic acid/dimethylaminohydroxypropyl diethylenetriamine copolymer; adipic acid/epoxypropyl diethylenetriamine copolymer; polyvinyl alcohol; methacryloyl ethyl betaine/methacrylates copolymer; ethyl acrylate/methyl methacrylate/methacrylic acid/acrylic acid copolymer; polyamine resins; and polyquaternary amine resins; poly(ethenylformamide); poly(vinylamine) hydrochloride; poly(vinyl alcohol-co-6% vinylamine); poly(vinyl alcohol-co-12% vinylamine); poly(vinyl alcohol-co-6% vinylamine hydrochloride); and poly(vinyl alcohol-co-12% vinylamine hydrochloride). Preferably, said copolymer and/or homopolymers are selected from the group consisting of adipic acid/dimethylaminohydroxypropyl diethylenetriamine copolymer; poly(vinylpyrrolidone/dimethylaminoethyl methacrylate); polyvinyl alcohol; ethyl acrylate/methyl methacrylate/ethacrylic acid/acrylic acid copolymer; methacryloyl ethyl betaine/methacrylates copolymer; polyquaternary amine resins; poly(ethenylformamide); poly(vinylamine) hydrochloride; poly(vinyl alcohol-co-6% vinylamine); poly(vinyl alcohol-co-12% vinylamine); poly(vinyl alcohol-co-6% vinylamine hydrochloride); and poly(vinyl alcohol-co-12% vinylamine hydrochloride).

Polymers useful in the present invention can be selected from the group consisting of copolymers of hydrophilic monomers. The polymer can be linear random or block copolymers, and mixtures thereof. The term “hydrophilic” is used herein consistent with its standard meaning of having affinity for water. As used herein in relation to monomer units and polymeric materials, including the copolymers, “hydrophilic” means substantially water-soluble.

Nonlimiting examples of useful hydrophilic monomers are unsaturated organic mono- and polycarboxylic acids, such as acrylic acid, methacrylic acid, crotonic acid, malieic acid and its half esters, itaconic acid; unsaturated alcohols, such as vinyl alcohol, allyl alcohol; polar vinyl heterocyclics, such as, vinyl caprolactam, vinyl pyridine, vinyl imidazole; vinyl amine; vinyl sulfonate; unsaturated amides, such as acrylamides, e.g., N,N-dimethylacrylamide, N-t-butyl acrylamide; hydroxyethyl methacrylate; dimethylaminoethyl methacrylate; salts of acids and amines listed above; and the like; and mixtures thereof. Some preferred hydrophilic monomers are acrylic acid, methacrylic acid, N,N-dimethyl acrylamide, N,N-dimethyl methacrylamide, N-t-butyl acrylamide, dimethylamino ethyl methacrylate, thereof, and mixtures thereof.

Polycarboxylate polymers are those formed by polymerization of monomers, at least some of which contain carboxylic functionality. Common monomers include acrylic acid, maleic acid, ethylene, vinyl pyrrolidone, methacrylic acid, methacryloylethylbetaine, etc. Preferred polymers for substantivity are those having higher molecular weights. For example, polyacrylic acid having molecular weights below about 10,000 are not particularly substantive and therefore do not normally provide hydrophilicity for three rewettings with all compositions, although with higher levels and/or certain surfactants like amphoteric and/or zwitterionic detergent surfactants, molecular weights down to about 1000 can provide some results. Non-limiting examples of polymers for use in the present invention include the following: poly(vinyl pyrrolidone/acrylic acid), poly(acrylic acid), and sulfonated polystyrene polymers.

Nanoparticles: Nanoparticles, which are defined as particles with diameters of about 400 nm or less, are technologically significant, since they are utilized to fabricate structures, coatings, and devices that have novel and useful properties due to the very small dimensions of their particulate constituents. “Non-photoactive” nanoparticles do not use UV or visible light to produce the desired effects. Nanoparticles can have many different particle shapes. Shapes of nanoparticles can include, but are not limited to spherical, parallel piped-shaped, tube shaped, and disc or plate shaped.

Inorganic nanoparticles generally exist as oxides, silicates, carbonates and hydroxides. These nanoparticles are generally hydrophilic. Some layered clay minerals and inorganic metal oxides can be examples of nanoparticles. The layered clay minerals suitable for use in the coating composition include those in the geological classes of the smectites, the kaolins, the illites, the chlorites, the attapulgites and the mixed layer clays. Smectites include montmorillonite, bentonite, pyrophyllite, hectorite, saponite, sauconite, nontronite, talc, beidellite, volchonskoite and vermiculite. Kaolins include kaolinite, dickite, nacrite, antigorite, anauxite, halloysite, indellite and chrysotile. Elites include bravaisite, muscovite, paragonite, phlogopite and biotite. Chlorites include corrensite, penninite, donbassite, sudoite, pennine and clinochlore. Attapulgites include sepiolite and polygorskyte. Mixed layer clays include allevardite and vermiculitebiotite. Variants and isomorphic substitutions of these layered clay minerals offer unique applications. The inorganic metal oxides used in the coating composition may be silica- or alumina-based nanoparticles that are naturally occurring or synthetic.

In some preferred embodiments, the nanoparticles will have a net excess charge on one of their dimensions. For instance, flat plate-shaped nanoparticles may have a positive charge on their flat surfaces, and a negative charge on their edges. Alternatively, such flat plate-shaped nanoparticles may have a negative charge on their flat surfaces and a positive charge on their edges. Preferably, the nanoparticles have an overall net negative charge. This is believed to aid in hydroplilizing the surface coated with the nanoparticles. The amount of charge, or “charge density”, on the nanoparticles can be measured in terms of the mole ratio of magnesium oxide to lithium oxide in the nanoparticles. In some embodiments, the nanoparticles have a mole ratio of magnesium oxide to lithium oxide of less than or equal to about 11%.

Depending upon the application, the use of nanoparticles provides great flexibility in engineering the desired properties of the coating composition used in the present invention. The individual platelets described above are negatively charged on their faces and possess a high concentration of surface bound water. When applied to a hard surface, the hard surface is hydrophilically modified and exhibits surprising and significantly improved wetting and sheeting, quick drying, uniform drying, anti-spotting, anti-soil deposition, cleaner appearance, enhanced gloss, enhanced color, minor surface defect repair, improved smoothness, anti-hazing properties, modification of surface friction, reduced damage to abrasion and improved transparency properties. In addition, the modified surface exhibits “self-cleaning” properties (dirt removal via water rinsing, e.g. from rainwater) and/or soil release benefits (top layers are strippable via mild mechanical action).

In contrast to hydrophilic modification with organic polymers, the benefits provided by nanoparticles, either alone or in combination with a charged modifier, are longer lived. For example, sheeting/anti-spotting benefits are maintained on an automobile body and glass window after multiple rinses versus the duration of such benefits after only about one rinse with tap water or rainwater on a surface coated with hydrophilic polymer technology.

Fragrance within Pads: Compositions of the present invention may comprise from about 0.01% to about 50% by weight of a fragrance oil to provide a perceptible aromatic result to the user during and after cleaning with cleaning implements using consumable pads and/or compliant pads according to embodiments of the invention. As used herein the term “fragrance oil” relates to the mixture of perfume raw materials that are used to impart an overall pleasant odor profile to a composition. As used herein the term “perfume raw material” relates to any chemical compound which is odiferous when in an un-entrapped state, for example in the case of pro-perfumes, the perfume component is considered, for the purposes of this invention, to be a perfume raw material, and the pro-chemistry anchor is considered to be the entrapment material.

Volatile perfume raw materials useful in the present invention are selected from, but are not limited to, aldehydes with a relative molecular mass of less than or equal to about 200, esters with a relative molecular mass of less than or equal to about 225, terpenes with a relative molecular mass of less than or equal to about 200, alcohols with a relative molecular mass of less than or equal to about 200 ketones with a relative molecular mass of less than or equal to about 200, nitriles, pyrazines, and mixtures thereof.

Examples of volatile perfume raw materials having a boiling point of less than, or equal to, 250° C., with a low odor detection are selected from, but are not limited to, anethol, methyl heptine carbonate, ethyl aceto acetate, para cymene, nerol, decyl aldehyde, para cresol, methyl phenyl carbinyl acetate, ionone alpha, ionone beta, undecylenic aldehyde, undecyl aldehyde, 2,6-nonadienal, nonyl aldehyde, octyl aldehyde. Further examples of volatile perfume raw materials having a boiling point of less than, or equal to, 250° C., which are generally known to have a low odour detection threshold include, but are not limited to, phenyl acetaldehyde, anisic aldehyde, benzyl acetone, ethyl-2-methyl butyrate, damascenone, damascone alpha, damascone beta, flor acetate, frutene, fructone, herbavert, iso cyclo citral, methyl isobutenyl tetrahydro pyran, iso propyl quinoline, 2,6-nonadien-1-ol, 2-methoxy-3-(2-methylpropyl)-pyrazine, methyl octine carbonate, tridecene-2-nitrile, allyl amyl glycolate, cyclogalbanate, cyclal C, melonal, gamma nonalactone, c is 1,3-oxathiane-2-methyl-4-propyl.

Other volatile perfume raw materials having a boiling point of less than, or equal to, 250° C., which are useful in the present invention, which have a high odor detection threshold, are selected from, but are not limited to, benzaldehyde, benzyl acetate, camphor, carvone, borneol, bornyl acetate, decyl alcohol, eucalyptol, linalool, hexyl acetate, iso-amyl acetate, thymol, carvacrol, limonene, menthol, iso-amyl alcohol, phenyl ethyl alcohol, alpha pinene, alpha terpineol, citronellol, alpha thujone, benzyl alcohol, beta gamma hexenol, dimethyl benzyl carbinol, phenyl ethyl dimethyl carbinol, adoxal, allyl cyclohexane propionate, beta pinene, citral, citronellyl acetate, citronellal nitrile, dihydro myrcenol, geraniol, geranyl acetate, geranyl nitrile, hydroquinone dimethyl ether, hydroxycitronellal, linalyl acetate, phenyl acetaldehyde dimethyl acetal, phenyl propyl alcohol, prenyl acetate, triplal, tetrahydrolinalool, verdox, cis-3-hexenyl acetate.

Examples of residual “middle and base note” perfume raw materials having a boiling point of greater than 250° C., which have a low odor detection threshold are selected from, but are not limited to, ethyl methyl phenyl glycidate, ethyl vanillin, heliotropin, indol, methyl anthranilate, vanillin, amyl salicylate, coumarin. Further examples of residual perfume raw materials having a boiling point of greater than 250° C. which are generally known to have a low odour detection threshold include, but are not limited to, ambrox, bacdanol, benzyl salicylate, butyl anthranilate, cetalox, ebanol, cis-3-hexenyl salicylate, lilial, gamma undecalactone, gamma dodecalactone, gamma decalactone, calone, cymal, dihydro iso jasmonate, iso eugenol, lyral, methyl beta naphthyl ketone, beta naphthol methyl ether, para hydroxylphenyl butanone, 8-cyclohexadecen-1-one, oxocyclohexadecen-2-one/habanolide, florhydral, intreleven aldehyde.

Other residual “middle and base note” perfume raw materials having a boiling point of greater than 250° C. which are useful in the present invention, but which have a high odour detection threshold, are selected from, but are not limited to, eugenol, amyl cinnamic aldehyde, hexyl cinnamic aldehyde, hexyl salicylate, methyl dihydro jasmonate, sandalore, veloutone, undecavertol, exaltolide/cyclopentadecanolide, zingerone, methyl cedrylone, sandela, dimethyl benzyl carbinyl butyrate, dimethyl benzyl carbinyl isobutyrate, triethyl citrate, cashmeran, phenoxy ethyl isobutyrate, iso eugenol acetate, helional, iso E super, ionone gamma methyl, pentalide, galaxolide, phenoxy ethyl propionate.

Entrapment Material for Pads: Compositions of the present invention comprise an entrapment material. As defined herein an “entrapment material” is any material which, after application of the composition to a consumable pad and/or compliant pad, suppresses the volatility of the perfume raw materials within the fragrance oil thus delaying their evaporation. It is not necessary that the entrapment material forms an association with the perfume raw material within the composition itself, only that this association exists on the consumable pad and/or compliant pad after application of the composition. Non-limiting examples of mechanisms by which the delay in evaporation may occur are by the entrapment material reversibly or irreversibly, physically or chemically associating with the perfume raw material through complexing, encapsulating, occluding, absorbing, binding, or otherwise adsorbing the perfume raw materials of the fragrance oil.

As defined herein “reversible entrapment” means that any entrapment material: perfume raw material association in which the association can be broken down so that the entrapment material and perfume raw materials are released from each other. As defined herein “irreversible entrapment” means that the entrapment material: perfume raw material association cannot be broken down. As defined herein “chemically associated” means that the entrapment material and perfume raw material are linked through a covalent, ionic, hydrogen or other type of chemical bond. As defined herein “physically associated” means that the entrapment material and perfume raw material are linked through a bond with a weaker force such as a Van der Waals force. Highly preferred is that, upon the consumable pad and/or compliant pad, the entrapment material and the perfume raw material form a reversible physical or chemical association.

As defined herein “to delay the evaporation of a perfume raw material” means to slow down or inhibit the evaporation rate of said perfume raw material from the consumable pad and/or compliant pad such that the fragrance “top note” character of the perfume raw material is detectable for a predetermined period, typically a few hours, after application by the consumable pad and/or compliant pad.

Entrapment materials for use herein are selected from polymers; capsules, microcapsules and nanocapsules; liposomes; pro-perfumes selected from more than 1 type of pro-chemistry; film formers; absorbents; cyclic oligosaccharides and mixtures thereof. Preferred are pro-perfumes selected from more than 1 type of pro-chemistry, absorbents and cyclic oligosaccharides and mixtures thereof. Highly preferred are cyclic oligosaccharides. It is preferred for compositions of the present invention that the entrapment material reversibly, chemically and physically complexes the perfume raw materials. Non limiting, and preferred, examples of entrapment materials that can act in this way are cyclic oligosaccharides, or mixtures of different cyclic oligosaccharides.

The cyclic oligosaccharide, or mixture of cyclic oligosaccharides, for use herein may be substituted by any suitable substituent or mixture of substituents. Herein the use of the term “mixture of substituent's” means that two or more different suitable substituent's can be substituted onto one cyclic oligosaccharide. The derivatives of cyclodextrins consist mainly of molecules wherein some of the OH groups have been substituted. Suitable substituent's include, but are not limited to, alkyl groups; hydroxyalkyl groups; dihydroxyalkyl groups; (hydroxyalkyl)alkylenyl bridging groups such as cyclodextrin glycerol ethers; aryl groups; maltosyl groups; allyl groups; benzyl groups; alkanoyl groups; cationic cyclodextrins such as those containing 2-hydroxy-3-(dimethylamino)propyl ether; quaternary ammonium groups; anionic cyclodextrins such as carboxyalkyl groups, sulphobutylether groups, sulphate groups, and succinylates; amphoteric cyclodextrins; and mixtures thereof.

The substituent's may be saturated or unsaturated, straight or branched chain, and may include saturated and straight chain alkyl groups, hydroxyalkyl groups and mixtures thereof. Preferred alkyl and hydroxyalkyl substituent's are selected from C1-C8 alkyl or hydroxyalkyl groups or mixtures thereof, more preferred alkyl and hydroxyalkyl substituents are selected from C1-C6 alkyl or hydroxyalkyl groups or mixtures thereof, even more preferred alkyl and hydroxyalkyl substituents are selected from C1-C4 alkyl or hydroxyalkyl groups and mixtures thereof. Especially preferred alkyl and hydroxyalkyl substituents are propyl, ethyl and methyl, more especially hydroxypropyl and methyl and even more preferably methyl.

Encapsulation Using Capsules, Micro-Capsules and Nanocapsules in Pads: Encapsulation of fragrances within capsules, micro-capsules or nanocapsules which are broken down by environmental triggers can be used to reduce the volatility of fragrance oils by surrounding the oil by small droplets as a resistant wall. This may be either water sensitive or insensitive. In the first case the fragrance is released when the encapsulated particle is affected by moisture loss from the “skin” of the particle; while in the second case the capsule wall must be ruptured mechanically before the fragrance is released. Moisture sensitive capsules, micro-capsules and nanocapsules may be preferably formed from, but not limited to, a polysaccharide polymer. Examples of suitable polymers are dextrins, especially low-viscosity dextrins including maltodextrins. A further example of a polysaccharide that can be used to form the moisture sensitive capsules is gum acacia.

Time release micro-capsules are also suitable for use in compositions of the present invention for entrapping hydrophobic perfume raw materials. Such compositions comprise the perfume raw materials encapsulated in a wax or polymer matrix which in turn is coated with a compatible surfactant. Film formers can also be used to reduce the volatility profile of perfume raw materials. When the fragrance is applied to a consumable pad and/or compliant pad, such as the skin, it is believed that film formers entrap the perfume oils during the evaporation of the volatile solvent thus hindering the release of the volatile material. Any film former which is compatible with the perfume raw materials may be used, preferably the film former will be soluble in water-ethanol mixture. Film former materials useful in this invention include, but are not limited to, ionic and non-ionic derivatives of water soluble polymers. Examples of suitable film forming materials are water soluble polymers containing a cationic moiety such as polyvinyl pyrrolidine and its derivatives having a molecular weight of 50,000 to 1,000,000. Other examples of ionic polymeric film forming materials are cationic cellulose derivatives and ethoxylated polyethyleneimine. Examples of suitable cellulosic derivatives such as hydroxymethyl cellulose, hydroxypropyl methylcellulose and hydroxyethyl cellulose. Another example of film formers is benzophenone.

Additional non-limiting examples of other polymer systems that can be used include water soluble anionic polymers e.g., polyacrylic acids and their water-soluble salts are useful in the present invention to delay the evaporation rate of certain amine-type odours. Preferred polyacrylic acids and their alkali metal salts have an average molecular weight of less than about 20,000, preferably less than 10,000, more preferably from about 500 to about 5,000. Polymers containing sulphonic acid groups, phosphoric acid groups, phosphonic acid groups and their water soluble salts, and their mixtures thereof, and mixtures with carboxylic acid and carboxylate groups, are also suitable. Water soluble polymers containing both cationic and anionic functionalities are also suitable.

Synthesising pro-perfumes or pro-fragrances from perfume raw materials can result in compounds which impart a delayed release mechanism to that specific perfume raw material. Pro-perfumes useful within the present invention include those selected from more than 1 type of pro-chemistry which ensures that a wide range of possible perfume raw materials can be used. This is consistent with the objective of providing unique fragrances with a broad spectrum of “top note” characters.

Within a pro-perfume the perfume raw material has been reacted with more than one type of chemical groups such as acetal, ketal, ester, hydrolysable inorganic-organic. As such, as defined within the present invention, the perfume raw material is considered to constitute part of the fragrance oil and the chemical groups to constitute part of the entrapment material. Pro-perfumes themselves are designed to be non-volatile, or else have a very low volatility. However, once on the consumable pad and/or compliant pad, the perfume raw material is released from the pro-perfume. Once released the perfume raw material has its original characteristics. The perfume raw material may be released from the pro-perfume in a number of ways. For example, it may be released as a result of simple hydrolysis, or by shift in an equilibrium reaction or by a pH-change, or by enzymatic release. The fragrances herein can be relatively simple in their compositions, comprising a single chemical, or can comprise highly sophisticated complex mixtures of natural and synthetic chemical components, all chosen to provide any desired odor.

When clarity of solution is not needed, odour absorbing materials such as zeolites and/or activated carbon can be used to modify the release rate of perfume raw materials. A preferred class of zeolites is characterised as “intermediate” silicate/aluminate zeolites. The intermediate zeolites are characterised by SiO2/AlO2 molar ratios of less than about 10. The intermediate zeolites have an advantage over the “high” zeolites since they have an affinity for amine-type odors, they are more weight efficient for odor absorption since they have a larger surface area and they are more moisture tolerant and retain more of their odour absorbing capacity in water than the high zeolites.

Carbon materials suitable for use in the present invention are materials well known in commercial practice as absorbents for organic molecules and/or for air purification purposes. Often, such carbon material is referred to as “activated” carbon or “activated charcoal”. Other odor absorbers suitable for use herein include silica molecular sieves, activated alumina, bentonite and kaolonite.

The fragrance may contain a volatile solvent. Preferably the volatile solvents for use herein will be safe for use on a wide range of consumable pad and/or compliant pads, and will more preferably be so on human or animal skin or hair. Suitable volatile solvents include, but are not limited to, those found in “CTFA International Cosmetic Ingredient Dictionary and Handbook” (The Cosmetic, Toiletry, and Fragrance Association, Inc.). Conventionally used volatile solvents include C3-C14 saturated and unsaturated, straight or branched chain hydrocarbons such as cyclohexane, hexane, heptane, isooctane, isopentane, pentane, toluene, xylene; halogenated alkanes such as perfluorodecalin; ethers such as dimethyl ether, diethyl ether; straight or branched chain alcohols and diols such as methanol, ethanol, propanol, isopropanol, n-butyl alcohol, t-butyl alcohol, benzyl alcohol, butoxypropanol, butylene glycol, isopentyldiol; aldehydes and ketones such as acetone; volatile silicones such as cyclomethicones for example octamethyl cyclo tetrasiloxane and decamethyl cyclopentane siloxane; volatile siloxanes such as phenyl pentamethyl disiloxane, phenylethylpentamethyl disiloxane, hexamethyl disiloxane, methoxy propylheptamethyl cyclotetrasiloxane, chloropropyl pentamethyl disiloxane, hydroxypropyl pentamethyl disiloxane, octamethyl cyclotetrasiloxane, decamethyl cyclopentasiloxane; propellants, and mixtures thereof. Preferred volatile solvents are ethers such as dimethyl ether, diethyl ether; straight or branched chain alcohols and diols such as methanol, ethanol, propanol, isopropanol, n-butyl alcohol, t-butyl alcohol, benzyl alcohol, butoxypropanol, butylene glycol, isopentyldiol; volatile silicones such as cyclomethicones for example octamethyl cyclo tetrasiloxane and decamethyl cyclopentane siloxane; propellants, and mixtures thereof. More preferred for use herein are C1-C4 straight chain or branched chain alcohols for example methanol, ethanol, propanol, isopropanol and butanol and mixtures thereof, and most preferred for use herein is ethanol.

The fragrance component may also comprise “nonvolatile” solvents. Suitable non-volatile solvents include, but are not limited to, benzyl benzoate, diethyl phthalate, isopropyl myristate, and mixtures thereof.

Water in Pads: Since the composition is an aqueous composition, water can be, along with the solvent, a predominant ingredient. The water may be deionized, industrial soft water, or any suitable grade or water. Where the cleaning composition is concentrated, the water may be present in the composition at a concentration of less than about 85 wt. %.

Methods of Use of Pads: The consumable pad and/or compliant pad can be used for cleaning, disinfecting, or sanitization on inanimate, household surfaces, including baseboard, cornices, panel moldings, casings, door jambs, crown moldings, coving, picture rails and chair rails. These surfaces may be formed from a variety of materials but are typically treated wood, varnished or stained wood, painted wood or plaster with paper fiber casing that has been painted. Other surfaces may include stainless steel, chrome, glass, and plastics. The consumable pad and/or compliant pad can be packaged individually or together in containers. Whilst primarily intended for use with a cleaning implemented other embodiments of the invention may be conceived that do not require additional cleaning implements but are hand held products for cleaning a variety of other surfaces that benefit from the combination of a compliant pad in conjunction with a consumable pad.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method comprising:
providing a compliant pad for demountable attachment to a cleaning implement, the compliant pad being formed from a material allowing the compliant pad to approximately match the contour of a surface to which it is applied; and
providing a consumable pad for demountable attachment to at least one of the compliant pad and the cleaning implement wherein the consumable pad is disposed between the compliant pad and the surface and provides for retention of material transferred from the surface to the consumable pad during a movement of the consumable pad relative to the surface.

2. The method according to claim 1 wherein,
providing the compliant pad comprises providing a pad comprising a plurality of layers, each layer formed from a predetermined material with a predetermined function in a predetermined pattern.

3. The method according to claim 2 wherein,
the predetermined function is at least one of providing a solvent, providing a cleaning agent, providing a fragrance, providing water, and providing structural compliance.

4. The method according to claim 1 wherein,
providing the consumable pad comprises providing a pad comprising a plurality of layers, each layer formed from a predetermined material with a predetermined function in a predetermined pattern.

5. The method according to claim 4 wherein,
the predetermined function is at least one of providing a solvent, providing a cleaning agent, providing a fragrance, providing water, providing structural compliance, displacing material from the surface, and retaining material displaced from the surface.

6. The method according to claim 1 wherein,
the compliant pad selectively releases a cleaning agent in response to at least one of water and a predetermined solvent provided in a controlled manner from the cleaning implement.

7. The method according to claim 6 wherein,
the predetermined solvent is held in a reservoir which is demountably attached to the cleaning implement.

8. The method according to claim 1 wherein,
providing the consumable pad comprises a plurality of consumable pads pre-assembled with the compliant pad, wherein a user sequentially removes each of the consumable pads after use.

9. The method according to claim 1 wherein,
providing the consumable pad comprises:
providing a first predetermined layer of a predetermined geometry formed from a material with low flexibility having a first predetermined portion of a demountable attachment means disposed in a predetermined position on a first surface;
providing a second predetermined layer formed from a low density polymer with elastic properties attached to a second surface of the first predetermined layer; and
providing a plurality of pockets dispersed within the second predetermined layer.

10. The method according to claim 9 wherein,
the plurality of pockets are at least one of in predetermined locations within the second predetermined layer or randomly dispersed.

11. The method according to claim 9 wherein,
the plurality of pockets are selectively opened through an erosion of the second predetermined layer.

12. A device comprising:
a compliant pad for demountable attachment to a cleaning implement, the compliant pad being formed from a material allowing the compliant pad to approximately match the contour of a surface to which it is applied; and
a consumable pad for demountable attachment to at least one of the compliant pad and the cleaning implement wherein the consumable pad is disposed between the compliant pad and the surface and provides for retention of material transferred from the surface to the consumable pad during a movement of the consumable pad relative to the surface.

13. The device according to claim 12 wherein,
the compliant pad comprises a plurality of layers, each layer formed from a predetermined material with a predetermined function in a predetermined pattern.

14. The device according to claim 13 wherein,
the predetermined function is at least one of a solvent, a cleaning agent, a fragrance, water, and structural compliance.

15. The device according to claim 12 wherein,
the consumable pad is at least one of:
comprised of a plurality of layers, each layer formed from a predetermined material with a predetermined function in a predetermined pattern; and
is one a plurality of consumable pads pre-assembled with the compliant pad.

16. The device according to claim 4 wherein,
the predetermined function is at least one of a solvent, a cleaning agent, a fragrance, providing water, structural compliance, displacing material from the surface, and retaining material displaced from the surface.

17. The device according to claim 12 wherein,
the compliant pad selectively releases a cleaning agent in response to at least one of water and a predetermined solvent provided in a controlled manner from the cleaning implement.

18. The device according to claim 12 wherein,
providing the consumable pad comprises:
providing a first predetermined layer of a predetermined geometry formed from a material with low flexibility having a first predetermined portion of a demountable attachment means disposed in a predetermined position on a first surface;
providing a second predetermined layer formed from a low density polymer with elastic properties attached to a second surface of the first predetermined layer; and
providing a plurality of pockets dispersed within the second predetermined layer.

19. The device according to claim 18 wherein,
the plurality of pockets are at least one of in predetermined locations within the second predetermined layer or randomly dispersed.

20. The device according to claim 18 wherein,
the plurality of pockets are selectively opened through an erosion of the second predetermined layer.
